(19) United States
(12) Patent Application Publication
(10) Pub. No.: US 2023/0326456 A1
(43) Pub. Date: Oct. 12, 2023

(54) EQUIPMENT CONTROL DEVICE AND EQUIPMENT CONTROL METHOD

(71) Applicant: Mitsubishi Electric Corporation, Tokyo (JP)

(72) Inventors: Masato HIRAI, Tokyo (JP); Daisuke IIZAWA, Tokyo (JP)

(73) Assignee: Mitsubishi Electric Corporation, Tokyo (JP)

(21) Appl. No.: 17/486,910

(22) PCT Filed: Apr. 23, 2019
(86) PCT No.: PCT/JP2019/017275

§ 371 Date: Sep. 28, 2021

(51) Int. Cl. G10L 15/22

(52) U.S. Cl. CPC G10L 15/22; G10L 2015/223; G10L 2015/225

(57) ABSTRACT

There are included an equipment and function information obtaining unit that obtains equipment and function information in which target equipment is associated with a target function to be performed by the target equipment, the target equipment and the target function being determined on the basis of a result of speech recognition; a time determining unit that determines whether or not time from utterance to performance of the target function is long; a response sentence determining unit that determines a first response sentence related to the target equipment, on the basis of the equipment and function information obtained by the equipment and function information obtaining unit, when the time determining unit determines that the time from utterance to performance of the target function is long; and an output control unit that outputs information indicating the first response sentence determined by the response sentence determining unit.

### CROSS-REFERENCE TO RELATED APPLICATION

The present application is a Bypass continuation of International Application No. PCT/JP2019/017275, filed Apr. 23, 2019, the entire contents of which being incorporated herein by reference in its entirety.

### TECHNICAL FIELD

The invention relates to an equipment control device and an equipment control method that control equipment on the basis of a result of speech recognition performed for uttered speech.

### BACKGROUND ART

Conventionally, there is known a technique in which various types of equipment are controlled on the basis of a result of speech recognition performed for user's uttered speech. In such a technique, it may take a long time for equipment to perform a function after utterance.

Here, Patent Literature 1 discloses a voice interactive system that outputs a “filler word” which is a tentative response, to fill response delay time before obtaining a result of speech recognition performed for user's utterance. In the voice interactive system of Patent Literature 1, the “filler word” is a simple response or back-channeling such as “uh-huh” or “um”.

### CITATION LIST

### Patent Literature

Patent Literature 1: JP 2018-45202 A

### SUMMARY OF INVENTION

### Technical Problem

In a technique in which equipment is controlled on the basis of a result of speech recognition performed for user's uttered speech, when time from utterance to performance of a function by the equipment is long, the user is kept waiting for a long time until the function is performed. During that period of time, in the conventional technique, there is a problem that the user cannot recognize whether or not the intended function is going to be performed by the equipment.

For such a problem, a technique disclosed in Patent Literature 1 is to fill response delay time before obtaining a result of speech recognition performed for utterance, and does not take into account time from utterance to performance of a function by equipment. In addition, a filler word outputted in the technique is merely a simple response or back-channeling. Thus, the above-described problem is still not solved by a technique such as that disclosed in Patent Literature 1.

The invention is made to solve a problem such as that described above, and an object of the invention is that in a technique in which equipment is controlled on the basis of a result of speech recognition performed for user's uttered speech, even when time from utterance to performance of a function by the equipment is long, during that period of time, the user can recognize whether or not the intended function is going to be performed by the equipment.

### Solution to Problem

An equipment control device according to the invention is an equipment control device that controls equipment on the basis of a result of speech recognition performed for uttered speech, and includes: processing circuitry to obtain equipment and function information in which target equipment is associated with a target function to be performed by the target equipment, the target equipment and the target function being determined on the basis of the result of speech recognition; to determine whether or not time from utterance to performance of the target function is long; to determine a first response sentence related to the target equipment, on the basis of the obtained equipment and function information, when it has been determined that the time from utterance to performance of the target function is long; to output information indicating the determined first response sentence; to measure first elapsed time from obtainment of the uttered speech; to generate a function command for performing the target function, on a basis of the obtained equipment and function information; and to output the generated function command to the target equipment, wherein when the measured first elapsed time has exceeded first target time, the processing circuitry determines that the time from utterance to performance of the target function is long, and when the processing circuitry has outputted the function command, the processing circuitry ends the measurement of the first elapsed time.

### Advantageous Effects of Invention

According to the invention, in a technique in which equipment is controlled on the basis of a result of speech recognition performed for user's uttered speech, even when time from utterance to performance of a function by the equipment is long, during that period of time, the user can recognize whether or not the intended function is going to be performed by the equipment.

### BRIEF DESCRIPTION OF DRAWINGS

FIG. 1 is a diagram for describing an example of a configuration of an equipment control system including an equipment control device according to a first embodiment.

FIG. 2 is a diagram showing exemplary schematic configurations of the equipment control device according to the first embodiment, a speech control device included in the equipment control device, and a home appliance.

FIG. 3 is a diagram showing an exemplary configuration of the speech control device included in the equipment control device according to the first embodiment.

FIG. 4 is a diagram showing exemplary configurations of a response output unit and a command control unit which are included in the equipment control device according to the first embodiment.

FIG. 5 is a diagram for describing examples of the content of response sentence information referred to by a response sentence determining unit upon determining a first response sentence in the first embodiment.

FIG. 6 is a diagram for describing examples of the content of performance response information stored in a storage unit in the first embodiment.

FIG. 7 is a flowchart for describing the operations of the equipment control device according to the first embodiment.

FIG. 8 is a flowchart for specifically describing the operations of the response output unit in the equipment control device according to the first embodiment.

FIG. 9 is a flowchart for specifically describing the operations of the command control unit in the equipment control device according to the first embodiment.

FIG. 10 is a diagram showing an outline of the flow of time up to the time when a first response sentence is outputted by voice from a voice output device in a case where the equipment control device according to the first embodiment has performed the operations described in FIGS. 8 and 9 and determined that required performance time is long.

FIG. 11 is a diagram showing an exemplary configuration of an equipment control device according to a second embodiment.

FIG. 12 is a flowchart for specifically describing the operations of a command control unit in the equipment control device according to the second embodiment.

FIG. 13 is a diagram showing an outline of the flow of time when the equipment control device according to the second embodiment has performed the operations described in FIGS. 8 and 12 and suspended output of a function command until output of a first response sentence by voice is completed.

FIG. 14 is a diagram showing an exemplary configuration of an equipment control device according to a third embodiment.

FIG. 15 is a flowchart for specifically describing the operations of a response output unit in the equipment control device according to the third embodiment.

FIG. 16 is a diagram showing an outline of the flow of time up to the time when a first response sentence is outputted by voice from a voice output device in a case where the equipment control device according to the third embodiment has performed the operations described in FIGS. 15 and 9 and determined that required performance time is long.

FIG. 17 is a diagram showing an exemplary configuration of an equipment control device according to a fourth embodiment.

FIG. 18 is a diagram for describing examples of the content of second response sentence information referred to by a response sentence determining unit upon determining a second response sentence in the fourth embodiment.

FIG. 19 is a flowchart for describing the detailed operations of a response output unit in the equipment control device according to the fourth embodiment.

FIG. 20 is a diagram showing an outline of the flow of time up to the time when a second response sentence is outputted by voice from a voice output device in a case where the equipment control device according to the fourth embodiment has performed the operations described in FIGS. 19 and 9 and determined that time elapsed from when information indicating a first response sentence is outputted is long.

FIG. 21 is a diagram showing an exemplary configuration of an equipment control device according to a fifth embodiment.

FIG. 22 is a diagram for describing examples of the content of first response sentence information referred to by a response sentence determining unit upon determining a first response sentence in the fifth embodiment.

FIG. 23 is a flowchart for describing the detailed operations of a response output unit in the equipment control device according to the fifth embodiment.

FIG. 24 is a diagram showing an outline of the flow of time up to the time when a voice output device is caused to output, by voice, a first response sentence with a length corresponding to first predicted elapsed time in a case where the equipment control device according to the fifth embodiment has performed the operations described in FIG. 23 and determined that required performance time is long.

FIG. 25 is a diagram showing an exemplary configuration of an equipment control device according to a sixth embodiment.

FIG. 26 is a flowchart for describing the detailed operations of a response output unit in the equipment control device according to the sixth embodiment.

FIG. 27 is a diagram showing an outline of the flow of time up to the time when a voice output device is caused to output, by voice, a first response sentence at a speed based on first predicted elapsed time in a case where the equipment control device according to the sixth embodiment has performed the operations described in FIG. 26 and determined that required performance time is long.

FIG. 28 is a diagram showing an exemplary configuration of an equipment control device according to a seventh embodiment.

FIG. 29 is a flowchart for describing the detailed operations of a response output unit in the equipment control device according to the seventh embodiment.

FIG. 30 is a diagram showing an outline of the flow of time in a case in which a message prompting a manual operation on target equipment is outputted by voice from a voice output device when the equipment control device according to the seventh embodiment has performed the operations described in FIG. 29 and determined that the degree of urgency of a target function to be performed by the target equipment is high.

FIG. 31 is a diagram showing an exemplary configuration of an equipment control device according to an eighth embodiment.

FIGS. 32A and 32B are diagrams showing examples of a hardware configuration of the equipment control devices according to the first to eighth embodiments.

FIG. 33 is a diagram showing an exemplary configuration of the equipment control system according to the first embodiment when in the equipment control system, a voice input device and the voice output device are mounted on the home appliance.

FIG. 34 is a diagram showing an exemplary configuration of the equipment control system according to the first embodiment when in the equipment control system, the equipment control device is mounted on the home appliance.

FIG. 35 shows an exemplary configuration of the equipment control system according to the first embodiment when in the equipment control system, the equipment control device, the voice input device, and the voice output device are mounted on the home appliance.

### DESCRIPTION OF EMBODIMENTS

Embodiments of the invention will be described in detail below with reference to the drawings.

### First Embodiment

An equipment control device 1 according to a first embodiment controls various types of equipment on the basis of results of speech recognition performed for user's uttered speech, to cause the equipment to perform their functions. In addition, when time from user's utterance to performance of a function by equipment is long, the equipment control device 1 according to the first embodiment can output, by voice, a response sentence related to the equipment.

Note that in the following description, as an example, equipment to be controlled by the equipment control device 1 according to the first embodiment is a home appliance used at home.

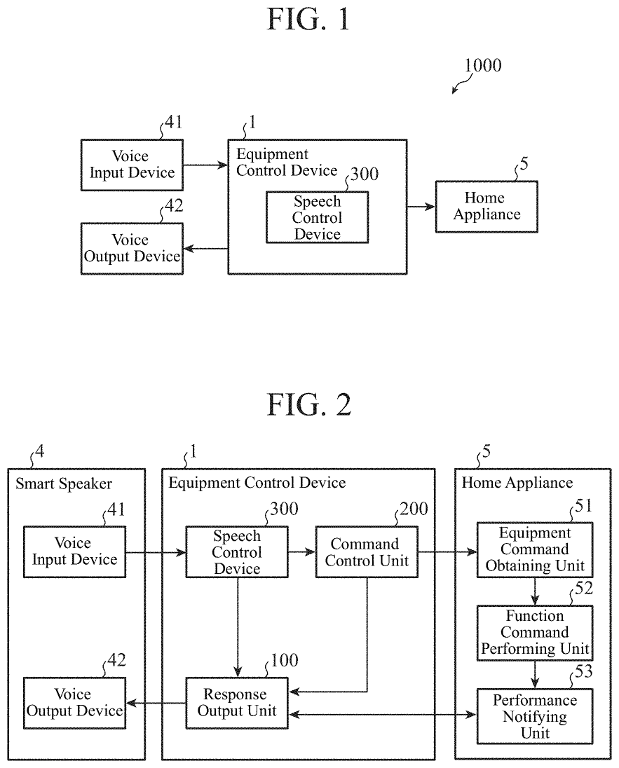

FIG. 1 is a diagram for describing an example of a configuration of an equipment control system 1000 including the equipment control device 1 according to the first embodiment.

The equipment control system 1000 includes the equipment control device 1, a voice input device 41, a voice output device 42, and a home appliance 5. The equipment control device 1 includes a speech control device 300.

The equipment control device 1 is, for example, provided in a server installed at a location external to a home, and connected to the voice input device 41, the voice output device 42, and the home appliance 5 through a network.

The home appliance 5 includes various electrical appliances used at home, e.g., a microwave oven, an induction heating (IH) stove, a rice cooker, a television set, and an air conditioner.

Note that although FIG. 1 shows only one home appliance 5 included in the equipment control system 1000, two or more home appliances 5 can be connected to the equipment control system 1000.

The speech control device 300 included in the equipment control device 1 performs a speech recognition process on user's uttered speech which is obtained from the voice input device 41, thereby obtaining a result of speech recognition. The speech control device 300 determines a home appliance 5 which is a control target and determines a function to be performed by the home appliance 5 among the functions of the home appliance 5, on the basis of the result of speech recognition.

In the first embodiment, a home appliance 5 which is a control target and is determined on the basis of a result of speech recognition performed for user's uttered speech is referred to as “target equipment”. In addition, among the functions of the “target equipment”, a function to be performed on the basis of the result of speech recognition performed for the user's uttered speech is also referred to as a “target function”.

The speech control device 300 outputs information in which the determined target equipment and target function are associated with each other (hereinafter, referred to as “equipment and function information”.) and the user's uttered speech to the equipment control device 1. The speech control device 300 may further include the result of speech recognition in the equipment and function information.

When the equipment control device 1 obtains uttered speech from the speech control device 300, the equipment control device 1 determines whether or not time from utterance to performance of a target function (hereinafter, referred to as “required performance time”.) is long. When the equipment control device 1 has determined that the required performance time is long, the equipment control device 1 determines a response sentence related to the target function, on the basis of equipment and function information obtained from the speech control device 300. When the equipment control device 1 has determined a response sentence related to the target function, the equipment control device 1 outputs information indicating the response sentence to the voice output device 42.

In addition, the equipment control device 1 generates a function command for performing the target function, on the basis of the equipment and function information outputted from the speech control device 300, and outputs the function command to target equipment.

When a performance completion notification that makes a notification about completion of performance of the target function based on the function command is outputted from the target equipment, the equipment control device 1 causes the voice output device 42 to output a performance response for making a notification about completion of performance of the target function by the target equipment.

The home appliance 5 performs its function on the basis of a function command outputted from the equipment control device 1.

When the home appliance 5 completes performance of its function on the basis of the function command outputted from the equipment control device 1, the home appliance 5 transmits a performance completion notification to the equipment control device 1.

The voice input device 41 is a microphone, etc., that can accept user's uttered speech and input a speech signal to the speech control device 300.

The voice output device 42 is a speaker, etc., that can output voice to the outside.

The voice input device 41 and the voice output device 42 may be those included in a so-called smart speaker.

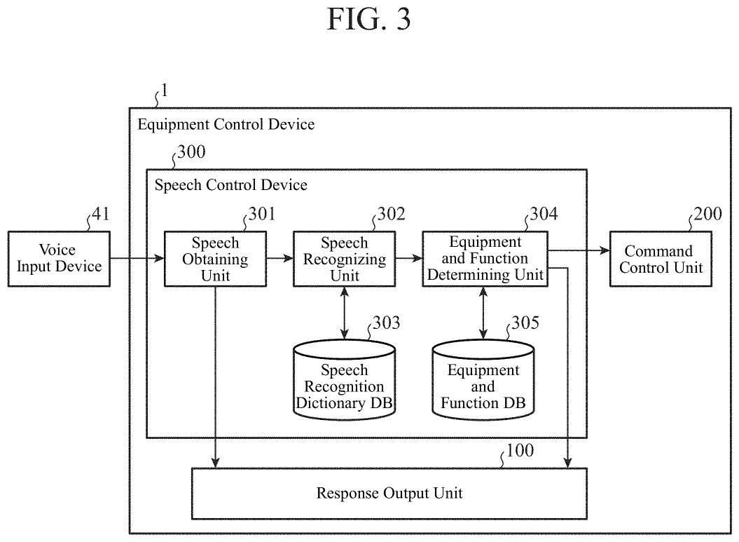

FIG. 2 is a diagram showing exemplary schematic configurations of the equipment control device 1 according to the first embodiment, the speech control device 300 included in the equipment control device 1, and the home appliance 5.

Note that in FIG. 2 the voice input device 41 and the voice output device 42 are included in a smart speaker 4.

As shown in FIG. 2, the equipment control device 1 includes a response output unit 100 and a command control unit 200 in addition to the speech control device 300. When the response output unit 100 obtains uttered speech from the speech control device 300, the response output unit 100 determines whether or not required performance time is long. When the response output unit 100 has determined that the required performance time is long, the response output unit 100 determines a response sentence related to a target function, on the basis of equipment and function information. When the response output unit 100 has determined a response sentence related to the target function, the response output unit 100 outputs information indicating the response sentence to the voice output device 42. The command control unit 200 generates a function command for performing the target function, on the basis of the equipment and function information outputted from the speech control device 300, and outputs the function command to target equipment.

A function command obtaining unit 51 in the home appliance 5 obtains a function command outputted from the command control unit 200 in the equipment control device 1.

A function command performing unit 52 in the home appliance 5 performs a target function of the home appliance 5 on the basis of the function command obtained by the function command obtaining unit 51.

When the function command performing unit 52 performs the target function, a performance notifying unit 53 in the home appliance 5 outputs a performance completion notification to the response output unit 100 in the equipment control device 1. Specifically, the performance notifying unit 53 transmits the performance completion notification to the response output unit 100 through a network.

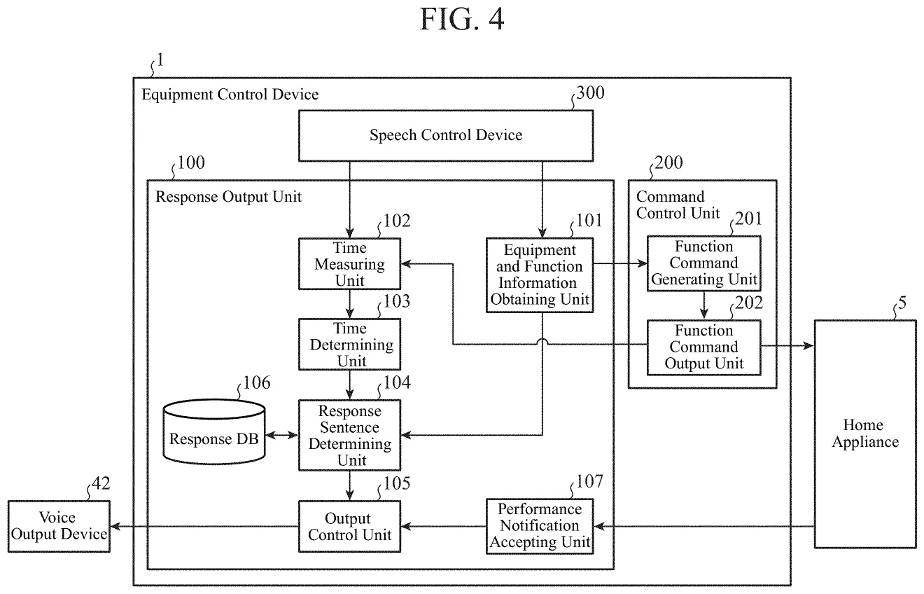

FIGS. 3 and 4 are diagrams showing an exemplary configuration of the equipment control device 1 according to the first embodiment, and FIG. 3 is a diagram showing an exemplary configuration of the speech control device 300 included in the equipment control device 1 according to the first embodiment, and FIG. 4 is a diagram showing exemplary configurations of the response output unit 100 and the command control unit 200 which are included in the equipment control device 1 according to the first embodiment. Note that for simplification of description, in FIG. 3, depiction of the voice output device 42 and the home appliance 5 is omitted, and in FIG. 4, depiction of the voice input device 41 is omitted.

For the configuration of the equipment control device 1, first, an exemplary configuration of the speech control device 300 included in the equipment control device 1 will be described using FIG. 3.

As shown in FIG. 3, the speech control device 300 includes a speech obtaining unit 301, a speech recognizing unit 302, a speech recognition dictionary database (DB) 303, an equipment and function determining unit 304, and an equipment and function DB 305.

The speech obtaining unit 301 obtains uttered speech from the voice input device 41.

A user utters to the voice input device 41 an instruction for performance of a function of the home appliance 5. For example, when an IH stove is included in the home appliance 5, the user utters to the voice input device 41, “Grill a slice of salmon on the IH stove”, by which the IH stove can be instructed to perform a function of grilling fish in slice mode. In addition, for example, when a grill microwave oven is included in the home appliance 5, the user utters, “Heat sake in the grill microwave oven”, by which the grill microwave oven can be instructed to perform a function of heating in hot sake mode.

The speech obtaining unit 301 obtains user's uttered speech accepted by the voice input device 41.

The speech obtaining unit 301 outputs the obtained uttered speech to the speech recognizing unit 302. In addition, the speech obtaining unit 301 outputs the obtained uttered speech to the response output unit 100.

The speech recognizing unit 302 performs a speech recognition process. The speech recognizing unit 302 may perform a speech recognition process using an existing speech recognition technique. In the equipment control device 1 according to the first embodiment, for example, the speech recognizing unit 302 performs a speech recognition process that identifies one or more words included in uttered speech, by checking the uttered speech obtained by the speech obtaining unit 301 against the speech recognition dictionary DB 303. When the speech recognizing unit 302 performs a speech recognition process that identifies one or more words included in uttered speech, a result of speech recognition includes, for example, the one or more words.

The speech recognition dictionary DB 303 is a database having stored therein a speech recognition dictionary for performing speech recognition.

The speech recognizing unit 302 checks uttered speech obtained by the speech obtaining unit 301 against the speech recognition dictionary stored in the speech recognition dictionary DB 303, thereby identifying words included in the uttered speech.

For example, description will be made using the above-described examples. For the uttered speech “Grill a slice of salmon on the IH stove”, the speech recognizing unit 302 identifies the words “grill”, “a slice of”, “salmon”, and “on the IH stove”. In addition, for example, for the uttered speech “Heat sake in the grill microwave oven”, the speech recognizing unit 302 identifies the words “heat”, “sake”, and “in the grill microwave oven”.

The speech recognizing unit 302 outputs a result of speech recognition to the equipment and function determining unit 304.

The equipment and function determining unit 304 determines target equipment and a target function by checking a result of speech recognition outputted from the speech recognizing unit 302 against the equipment and function DB 305.

The equipment and function DB 305 has equipment-related information stored therein. The equipment-related information is information in which a result of speech recognition is associated with a home appliance 5 and the result of speech recognition is associated with a function of the home appliance 5. Equipment-related information is generated in advance for one or more home appliances 5 that can be controlled by uttered speech, and is stored in the equipment and function DB 305.

For example, when a result of speech recognition outputted from the speech recognizing unit 302 includes “grill”, “a slice of”, “salmon”, and “on the IH stove”, the equipment and function determining unit 304 determines that the target equipment is an “IH stove”, on the basis of the equipment-related information. Furthermore, the equipment and function determining unit 304 determines that the target function includes, for example, “grill for grilling fish”, “slice mode”, and “heat level 4” of the “IH stove”.

In addition, for example, when a result of speech recognition outputted from the speech recognizing unit 302 includes “heat”, “sake”, and “in the grill microwave oven”, the equipment and function determining unit 304 determines that the target equipment is a “grill microwave oven”, on the basis of the equipment-related information. Furthermore, the equipment and function determining unit 304 determines that the target function includes, for example, “drink mode” and “set temperature of 50° C.” of the “grill microwave oven”.

The equipment and function determining unit 304 generates equipment and function information in which target equipment is associated with a target function, and outputs the generated equipment and function information to the response output unit 100 and the command control unit 200 in the equipment control device 1.

In a case of the above-described examples, the equipment and function determining unit 304 generates equipment and function information in which information of “IH stove” is associated with information of “grill for grilling fish”, “slice mode”, and “heat level 4”, and transmits the equipment and function information to the equipment control device 1. In addition, the equipment and function determining unit 304 generates equipment and function information in which information of “grill microwave oven” is associated with information of “drink mode” and “set temperature of 50° C.”, and transmits the equipment and function information to the equipment control device 1.

Note that in the above-described examples, the result of speech recognition includes an equipment name. However, this is merely an example, and the result of speech recognition may include no equipment name. Even when the result of speech recognition includes no equipment name, the equipment and function determining unit 304 can determine target equipment from words that make it possible to identify the target equipment and that are included in the result of speech recognition. For example, it is assumed that the user has uttered to the voice input device 41, “Grill a slice of salmon”. In this case, for the uttered speech “Grill a slice of salmon”, the speech recognizing unit 302 identifies the words “grill”, “a slice of”, and “salmon”. The equipment and function determining unit 304 determines, from, for example, the words “grill” and “a slice of”, that the target equipment is an “IH stove”. The equipment and function determining unit 304 generates equipment and function information in which target equipment determined from a result of speech recognition is associated with a target function determined on the basis of equipment-related information.

In addition, for example, if the number of pieces of target equipment that is instructed to perform a target function by user's utterance is one, there is a possibility that the content of the utterance does not include information that makes it possible to identify target equipment. However, in this case, since the target equipment is determined, the equipment and function determining unit 304 generates equipment and function information in which the determined target equipment is associated with a target function determined on the basis of equipment-related information.

Although, in the first embodiment, as shown in FIG. 3, the speech recognition dictionary DB 303 and the equipment and function DB 305 are included in the speech control device 300, this is merely an example. The speech recognition dictionary DB 303 and the equipment and function DB 305 may be provided in an area which is outside the speech control device 300 and which the speech control device 300 can refer to.

Next, using FIG. 4, the configurations of the response output unit 100 and the command control unit 200 which are included in the equipment control device 1 will be described.

The response output unit 100 includes an equipment and function information obtaining unit 101, a time measuring unit 102, a time determining unit 103, a response sentence determining unit 104, an output control unit 105, a response DB 106, and a performance notification accepting unit 107.

The command control unit 200 includes a function command generating unit 201 and a function command output unit 202.

The equipment and function information obtaining unit 101 in the response output unit 100 obtains equipment and function information outputted from the equipment and function determining unit 304 in the speech control device 300.

The equipment and function information obtaining unit 101 outputs the obtained equipment and function information to the response sentence determining unit 104 and the command control unit 200.

The time measuring unit 102 in the response output unit 100 measures elapsed time (hereinafter, referred to as “first elapsed time”) from a time at which uttered speech has been obtained (hereinafter, referred to as a “speech obtained time”.). In the first embodiment, for example, the speech obtained time is a time at which the speech obtaining unit 301 has obtained uttered speech. The time measuring unit 102 can obtain a speech obtained time from the speech obtaining unit 301. For example, the speech obtaining unit 301 adds information indicating a speech obtained time to uttered speech, and outputs the uttered speech with the information to the time measuring unit 102.

In addition, in the first embodiment, the speech obtained time may be a time at which the time measuring unit 102 has obtained uttered speech from the speech obtaining unit 301.

In the first embodiment, the time measuring unit 102 continues measuring the first elapsed time until the function command output unit 202 outputs a function command to the target equipment. The time measuring unit 102 can obtain information indicating that the function command output unit 202 has outputted a function command to the target equipment, from the function command output unit 202. When the time measuring unit 102 has obtained information indicating that a function command has been outputted to the target equipment, from the function command output unit 202, the time measuring unit 102 ends the measurement of the first elapsed time.

The time measuring unit 102 continuously outputs the first elapsed time to the time determining unit 103. When the time measuring unit 102 has obtained information indicating that a function command has been outputted to the target equipment, from the function command output unit 202, the time measuring unit 102 stops the output of the first elapsed time.

The time determining unit 103 determines whether or not required performance time is long. Specifically, the time determining unit 103 determines whether or not the first elapsed time obtained from the time measuring unit 102 has exceeded preset time (hereinafter, referred to as “first target time”.). As the first target time, for example, time is preset that is somewhat shorter than time estimated to cause the user to feel that “he or she is kept waiting” when there is no response from the target equipment, etc., during a period from utterance to performance of the target function. The time determining unit 103 makes the above-described determination, for example, every time first elapsed time is outputted from the time measuring unit 102.

When the first elapsed time has exceeded the first target time, the time determining unit 103 determines that the required performance time is long. As described above, when the time measuring unit 102 has obtained information indicating that a function command has been outputted to the target equipment, from the function command output unit 202, the time measuring unit 102 ends the measurement of the first elapsed time. A state in which the first elapsed time has exceeded the first target time indicates a state in which the first target time has already elapsed during a period from when uttered speech is obtained to when the function command output unit 202 outputs a function command to the target equipment. For example, in order not to make the user feel that “he or she is kept waiting”, there is a need to promptly output a response sentence which will be described later from the voice output device 42, etc., after the above-described state has been determined.

On the other hand, when the first elapsed time has not exceeded the first target time, the time determining unit 103 determines that the required performance time is not long. A state in which the first elapsed time has not exceeded the first target time indicates a state in which the first target time has not yet elapsed during a period from when uttered speech is obtained to when the function command output unit 202 outputs a function command to the target equipment.

When the time determining unit 103 has determined that the required performance time is long, the time determining unit 103 outputs information indicating that the required performance time is determined to be long (hereinafter, referred to as “function performance delay information”.) to the response sentence determining unit 104.

When the time determining unit 103 has determined that the required performance time is long, the response sentence determining unit 104 determines a response sentence related to the target equipment (hereinafter, referred to as a “first response sentence”.), on the basis of equipment and function information obtained by the equipment and function information obtaining unit 101.

The response sentence determining unit 104 determines a first response sentence on the basis of response sentence information which is generated in advance and stored in the response DB 106.

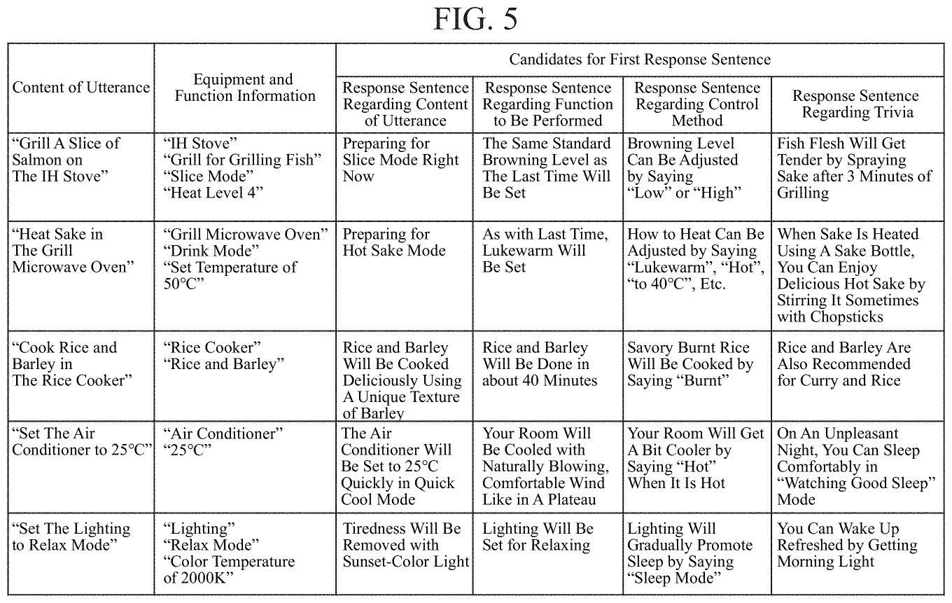

Here, FIG. 5 is a diagram for describing examples of the content of response sentence information referred to by the response sentence determining unit 104 upon determining a first response sentence in the first embodiment. In the following description, the response sentence information referred to by the response sentence determining unit 104 upon determining a first response sentence is referred to as “first response sentence information”.

The first response sentence information is information in which equipment and function information and candidates for a first response sentence that can become a first response sentence are defined in such a manner as to be associated with each other. Note that in FIG. 5, for easy understanding, the content of user's utterance (see the “content of utterance” field in FIG. 5) is shown in such a manner as to be associated with equipment and function information. As shown in FIG. 5, in the first response sentence information, for example, one piece of equipment and function information can be associated with a response sentence regarding the content of utterance, a response sentence regarding a function to be performed, a response sentence regarding a control method, and a response sentence regarding trivia which are candidates for a first response sentence.

The response sentence determining unit 104 determines a first response sentence from candidates for a first response sentence which are associated with, in the first response sentence information, equipment and function information obtained by the equipment and function information obtaining unit 101. The response sentence determining unit 104 may determine the first response sentence by a method according to the situation.

For example, when the equipment and function information obtained by the equipment and function information obtaining unit 101 is information in which information of “IH stove” is associated with information of “grill for grilling fish”, “slice mode”, and “heat level 4”, the response sentence determining unit 104 determines that “Preparing for slice mode right now” is the first response sentence.

The response sentence determining unit 104 outputs information indicating the determined first response sentence to the output control unit 105.

Note that the content of first response sentence information shown in FIG. 5 is merely an example. In first response sentence information, one piece of equipment and function information may be associated with only one candidate for a first response sentence, or a candidate for a first response sentence may be a response sentence related to target equipment other than a response sentence regarding the content of utterance, a response sentence regarding a function to be performed, a response sentence regarding a control method, and a response sentence regarding trivia. First response sentence information may be configured in any manner as long as the first response sentence information defines one or more first response sentences related to target equipment, as candidates for a first response sentence which correspond to one piece of equipment and function information. In addition, when a result of speech recognition is included in equipment and function information, first response sentence information stored in the response DB 106 may include information in which the result of speech recognition and candidates for a first response sentence that can become a first response sentence are defined in such a manner as to be associated with each other. In that case, the response sentence determining unit 104 can determine a first response sentence also from the candidates for a first response sentence associated with the result of speech recognition.

The output control unit 105 outputs information indicating a first response sentence determined by the response sentence determining unit 104 to the voice output device 42.

When the information indicating a first response sentence has been outputted from the output control unit 105, the voice output device 42 outputs the first response sentence by voice in accordance with the information indicating a first response sentence.

In addition, when information indicating that a performance completion notification has been accepted is outputted from the performance notification accepting unit 107, the output control unit 105 outputs information indicating a performance response. Specifically, when information indicating that a performance completion notification has been accepted is outputted, the output control unit 105 determines a performance response on the basis of performance response information, and outputs information indicating the performance response to the voice output device 42. The performance response information is generated in advance and stored in a storage unit (depiction is omitted). Note that the performance completion notification will be described later.

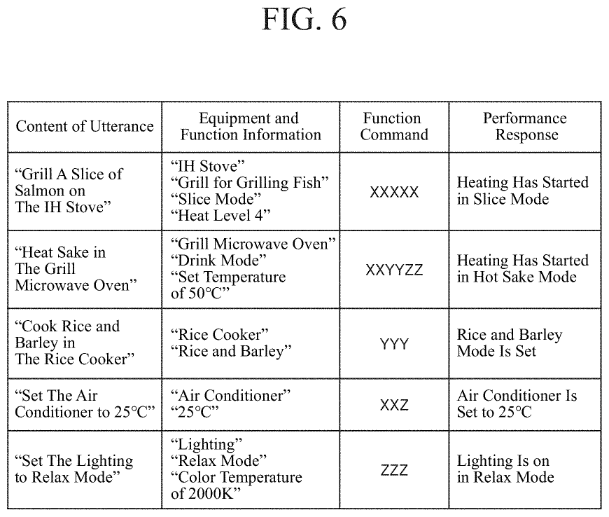

Here, FIG. 6 is a diagram for describing examples of the content of the performance response information stored in the storage unit in the first embodiment.

In the performance response information, a function command and the content of a performance response are defined in such a manner as to be associated with each other. Note that in FIG. 6, for easy understanding, the content of user's utterance (see the “content of utterance” field in FIG. 6) and equipment and function information are shown in such a manner as to be associated with a function command.

The output control unit 105 outputs, on the basis of performance response information such as that shown in FIG. 6, information indicating a performance response associated with a function command which is provided to information indicating that a performance completion notification has been accepted, to the voice output device 42. Note that it is assumed that the information indicating that a performance completion notification has been accepted which is outputted from the performance notification accepting unit 107 is provided with, for example, information indicating a function command, on the basis of which a target function is performed on target equipment. When the target equipment outputs a performance completion notification to the performance notification accepting unit 107, the target equipment outputs the performance completion notification provided with information indicating a function command.

For example, it is assumed that the equipment control device 1 has outputted, to the IH stove which is target equipment, a function command generated on the basis of equipment and function information in which information of “IH stove” is associated with information of “grill for grilling fish”, “slice mode”, and “heat level 4”, and the target equipment has performed a target function in accordance with the function command. In this case, the IH stove outputs a performance completion notification indicating that the target function has been performed, and the performance notification accepting unit 107 accepts the performance completion notification. In this case, the output control unit 105 outputs information indicating the performance response “Heating has started in slice mode” to the voice output device 42. The voice output device 42 outputs the performance response “Heating has started in slice mode” by voice.

The response DB 106 stores first response sentence information such as that shown in FIG. 5.

Note that although in the first embodiment, as shown in FIG. 4, the response DB 106 is included in the equipment control device 1, this is merely an example. The response DB 106 may be provided in an area which is outside the equipment control device 1 and which the response sentence determining unit 104 in the equipment control device 1 can refer to.

The performance notification accepting unit 107 accepts a performance completion notification outputted from the target equipment.

The performance notification accepting unit 107 outputs information indicating that the performance completion notification has been accepted, to the output control unit 105.

The function command generating unit 201 in the command control unit 200 generates a function command for causing target equipment to perform a target function, on the basis of equipment and function information obtained by the equipment and function information obtaining unit 101.

For example, when the equipment and function information obtained by the equipment and function information obtaining unit 101 is information in which information of “IH stove” is associated with information of “grill for grilling fish”, “slice mode”, and “heat level 4”, the command control unit 200 generates a function command for causing the IH stove to perform a function of grilling fish in slice mode at heat level 4 on the grill for grilling fish.

The function command generating unit 201 outputs the generated function command to the function command output unit 202.

The function command output unit 202 in the command control unit 200 outputs a function command generated by the function command generating unit 201 to target equipment. Specifically, the function command output unit 202 transmits the function command to the target equipment through a network.

Here, it may take time for the function command generating unit 201 to generate a function command after obtaining equipment and function information. This is because, for example, there is a case in which it takes time for the function command generating unit 201 to perform a process of generating a function command.

The function command output unit 202 waits until the function command generating unit 201 completes generation of a function command, and when the function command generating unit 201 completes the generation of a function command, the function command output unit 202 outputs the generated function command.

The operations of the equipment control device 1 will be described.

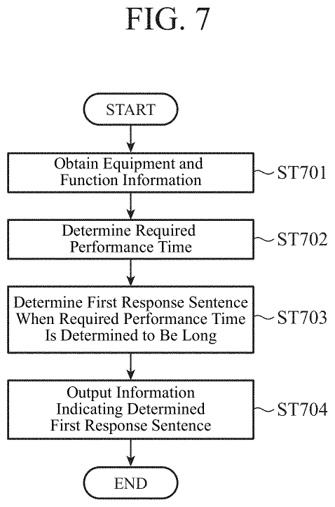

FIG. 7 is a flowchart for describing the operations of the equipment control device 1 according to the first embodiment.

In the equipment control device 1, the equipment and function information obtaining unit 101 obtains equipment and function information outputted from the equipment and function determining unit 304 in the speech control device 300 (step ST701).

The equipment and function information obtaining unit 101 outputs the obtained equipment and function information to the response sentence determining unit 104 and the function command generating unit 201.

The time determining unit 103 determines whether or not required performance time is long (step ST702).

If the time determining unit 103 has determined at step ST702 that the required performance time is long, then the response sentence determining unit 104 determines a first response sentence on the basis of the equipment and function information obtained by the equipment and function information obtaining unit 101 at step ST701 (step ST703).

The response sentence determining unit 104 outputs information indicating the determined first response sentence to the output control unit 105.

The output control unit 105 outputs the information indicating the first response sentence determined by the response sentence determining unit 104 at step ST703 (step ST704).

When the information indicating the first response sentence is outputted from the output control unit 105, the voice output device 42 outputs the first response sentence by voice.

The operations of the response output unit 100 and the command control unit 200 in the equipment control device 1 according to the first embodiment will be described in detail.

In the equipment control device 1, the operations of the response output unit 100 and the operations of the command control unit 200 are performed in parallel.

First, the operations of the response output unit 100 will be described in detail.

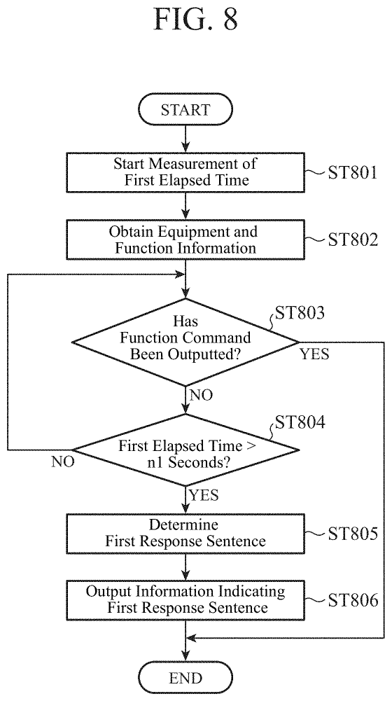

FIG. 8 is a flowchart for specifically describing the operations of the response output unit 100 in the equipment control device 1 according to the first embodiment.

Note that in the following description of the operations using FIG. 8, as an example, first target time which the time determining unit 103 compares with first elapsed time is “n1 seconds”.

The time measuring unit 102 starts measurement of first elapsed time (step ST801).

The time measuring unit 102 continuously outputs the first elapsed time to the time determining unit 103.

The equipment and function information obtaining unit 101 obtains equipment and function information outputted from the equipment and function determining unit 304 in the speech control device 300 (step ST802).

The equipment and function information obtaining unit 101 outputs the obtained equipment and function information to the response sentence determining unit 104 and the command control unit 200.

The time measuring unit 102 determines whether or not a function command has been outputted (step ST803). Specifically, the time measuring unit 102 determines whether or not information indicating that a function command has been outputted to target equipment has been obtained from the function command output unit 202.

If the time measuring unit 102 has determined at step ST803 that a function command has been outputted (if “YES” at step ST803), then the time measuring unit 102 ends the measurement of the first elapsed time, and the response output unit 100 ends the process. Note that the response output unit 100 ends the process after the performance notification accepting unit 107 accepts a performance completion notification transmitted from the target equipment and the output control unit 105 outputs information indicating a performance response.

If the time measuring unit 102 has determined at step ST803 that a function command has not yet been outputted (if “NO” at step ST803), then the time determining unit 103 determines whether or not the first elapsed time has exceeded n1 seconds (step ST804).

If the time determining unit 103 has determined at step ST804 that the first elapsed time has not exceeded n1 seconds (if “NO” at step ST804), then the time determining unit 103 determines that required performance time is not long, and returns to step ST803.

If the time determining unit 103 has determined at step ST804 that the first elapsed time has exceeded n1 seconds (if “YES” at step ST804), then the time determining unit 103 determines that the required performance time is long, and outputs function performance delay information to the response sentence determining unit 104.

When the function performance delay information is outputted from the time determining unit 103 at step ST804, the response sentence determining unit 104 determines a first response sentence on the basis of the equipment and function information obtained by the equipment and function information obtaining unit 101 at step ST802 (step ST805).

The response sentence determining unit 104 outputs information indicating the determined first response sentence to the output control unit 105.

The output control unit 105 outputs the information indicating the first response sentence determined by the response sentence determining unit 104 at step ST805 to the voice output device 42 (step ST806).

Next, the operations of the command control unit 200 will be described in detail.

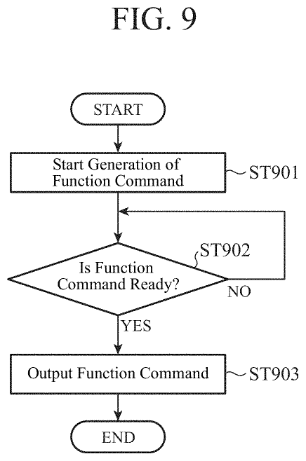

FIG. 9 is a flowchart for specifically describing the operations of the command control unit 200 in the equipment control device 1 according to the first embodiment.

The function command generating unit 201 obtains equipment and function information from the equipment and function information obtaining unit 101, and starts generation of a function command (step ST901).

The function command output unit 202 determines whether or not a function command is ready (step ST902). Specifically, the function command output unit 202 determines whether or not a function command generated by the function command generating unit 201 has been outputted from the function command generating unit 201.

If a function command is not ready at step ST902 (if “NO” at step ST902), then the function command output unit 202 waits until a function command is ready.

If a function command is ready at step ST902 (if “YES” at step ST902), then the function command output unit 202 outputs the function command generated by the function command generating unit 201 to the target equipment (step ST903).

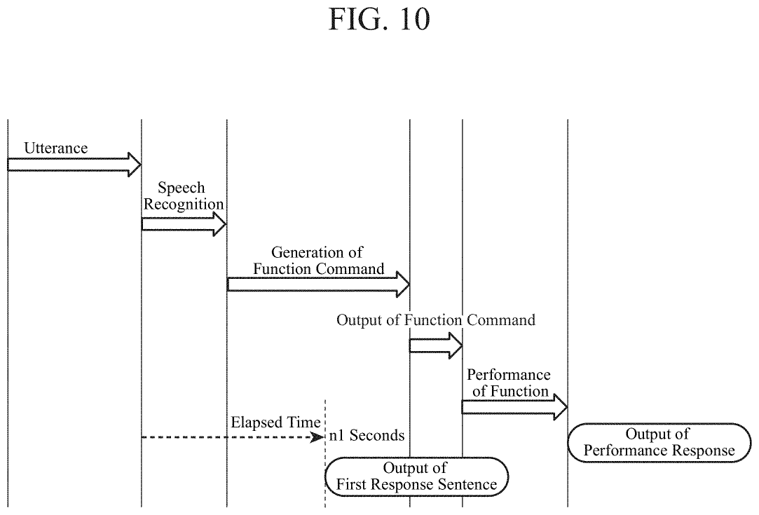

FIG. 10 is a diagram showing an outline of the flow of time up to the time when a first response sentence is outputted by voice from the voice output device 42 in a case where the equipment control device 1 according to the first embodiment has performed the operations described in FIGS. 8 and 9 and determined that required performance time is long.

As described above, when first elapsed time has exceeded first target time, the equipment control device 1 outputs information indicating a first response sentence. Namely, in the equipment control device 1, when the first target time has elapsed during a period from when uttered speech is obtained to when the function command output unit 202 outputs a function command, the time determining unit 103 determines that required performance time is long, and the output control unit 105 outputs information indicating a first response sentence determined by the response sentence determining unit 104 to the voice output device 42.

In the equipment control device 1, as described above, it may take time for the function command generating unit 201 to generate a function command because, for example, there is a case in which it takes time to perform a process of generating a function command. Hence, there is a case in which required performance time is long. In that case, there is a possibility that the user feels that waiting time until a target function instructed by utterance is performed by target equipment is long.

In consideration of this, in the equipment control device 1, as described above, when the first target time has elapsed during a period from when uttered speech is obtained to when the function command output unit 202 outputs a function command, the time determining unit 103 determines that required performance time is long, and the output control unit 105 outputs a first response sentence determined by the response sentence determining unit 104 to the voice output device 42.

As a result, even when the required performance time is long in a case where an instruction for performance of a target function by target equipment is given by the user making an utterance, during that period of time, the user can recognize whether or not the intended function is going to be performed by the equipment.

As described above, according to the first embodiment, the equipment control device 1 is configured to include the equipment and function information obtaining unit 101 that obtains equipment and function information in which target equipment is associated with a target function to be performed by the target equipment, the target equipment and the target function being determined on the basis of a result of speech recognition; the time determining unit 103 that determines whether or not time from utterance to performance of the target function is long; the response sentence determining unit 104 that determines a first response sentence related to the target equipment, on the basis of the equipment and function information obtained by the equipment and function information obtaining unit 101, when the time determining unit 103 has determined that the time from utterance to performance of the target function is long; and the output control unit 105 that outputs information indicating the first response sentence determined by the response sentence determining unit 104. Hence, in a technique in which equipment is controlled on the basis of a result of speech recognition performed for user's uttered speech, even when time from utterance to performance of a function by the equipment is long, during that period of time, the user can recognize whether or not the intended function is going to be performed by the equipment.

### Second Embodiment

In the first embodiment, in the equipment control device 1, the function command output unit 202 waits to output a function command until the function command generating unit 201 completes generation of the function command.

In a second embodiment, an embodiment will be described in which even when the function command generating unit 201 has completed generation of a function command, a function command output unit 202 suspends output of the function command if the voice output device 42 has not completed output, by voice, of a first response sentence based on information which indicates the first response sentence and which is outputted from an output control unit 105.

The configuration of an equipment control system 1000 including an equipment control device 1 according to the second embodiment is the same as the configuration of the equipment control system 1000 described using FIG. 1 in the first embodiment, and thus, an overlapping description is omitted.

In addition, the configuration of the equipment control device 1 according to the second embodiment is the same as the configuration described using FIGS. 2 to 4 in the first embodiment, and thus, an overlapping description is omitted.

Note that in the equipment control device 1 according to the second embodiment, the operations of the output control unit 105 and the function command output unit 202 differ from the operations of the output control unit 105 and the function command output unit 202 in the equipment control device 1 according to the first embodiment.

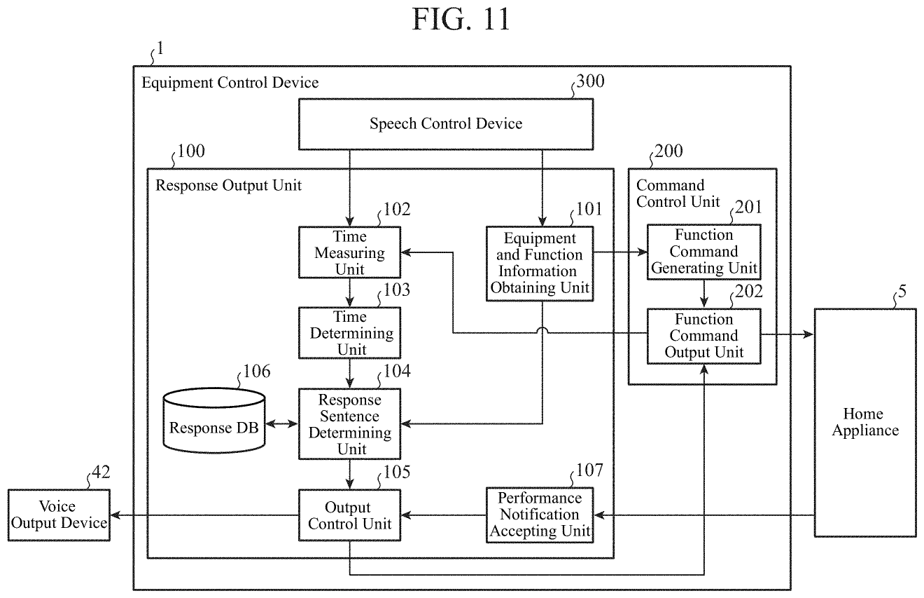

FIG. 11 is a diagram showing an exemplary configuration of the equipment control device 1 according to the second embodiment.

As shown in FIG. 11, the output control unit 105 outputs information indicating a first response sentence and information indicating a performance response to the voice output device 42, and outputs, when having outputted the information indicating a first response sentence, information indicating that the information indicating a first response sentence has been outputted, to the function command output unit 202. In addition, the output control unit 105 outputs a first response sentence output completion notification indicating that the voice output device 42 has completed output of the first response sentence by voice, to the function command output unit 202.

The output control unit 105 may determine that the voice output device 42 has completed output of a first response sentence by voice, on the basis of, for example, information which indicates the first response sentence and which is outputted to the voice output device 42. Specifically, the output control unit 105, for example, calculates, on the basis of the length of a first response sentence, time required to output the first response sentence by voice. The output control unit 105 determines a time obtained by adding the calculated time required to output the first response sentence by voice to a time at which information indicating the first response sentence is outputted to the voice output device 42, to be a time at which the voice output device 42 has completed output of the first response sentence by voice. Then, when the time has been reached, the output control unit 105 outputs a first response sentence output completion notification to the function command output unit 202.

In addition, for example, when the voice output device 42 has a function of notifying, upon completion of output of a first response sentence by voice, the equipment control device 1 of such a fact, the output control unit 105 may determine a time at which the equipment control device 1 obtains the notification from the voice output device 42, to be a time at which the voice output device 42 has completed output of the first response sentence by voice. When the equipment control device 1 obtains the notification from the voice output device 42, the output control unit 105 outputs a first response sentence output completion notification to the function command output unit 202.

Upon outputting, by the function command output unit 202, a function command generated by the function command generating unit 201, when the output control unit 105 has outputted information indicating a first response sentence to the voice output device 42 before the function command is outputted, and the voice output device 42 has not completed output, by voice, of the first response sentence based on the information indicating a first response sentence, the function command output unit 202 suspends transmission of the function command until the output of the first response sentence by voice is completed.

The function command output unit 202 may determine whether or not the output control unit 105 has outputted information indicating a first response sentence, on the basis of whether or not the function command output unit 202 has obtained, from the output control unit 105, information indicating that the information indicating a first response sentence has been outputted.

In addition, the function command output unit 202 may determine, on the basis of a first response sentence output completion notification outputted from the output control unit 105, whether or not the voice output device 42 has completed output, by voice, of a first response sentence based on information which indicates the first response sentence and which is outputted from the output control unit 105. Specifically, if a first response sentence output completion notification has been outputted from the output control unit 105, then the function command output unit 202 determines that output of a first response sentence by voice has been completed, and if a first response sentence output completion notification has not been outputted from the output control unit 105, then the function command output unit 202 determines that output of a first response sentence by voice has not been completed.

The operations of the command control unit 200 in the equipment control device 1 according to the second embodiment will be described in detail.

Note that the basic operations of the equipment control device 1 according to the second embodiment are the same as the basic operations of the equipment control device 1 which are described using the flowchart of FIG. 7 in the first embodiment, and thus, an overlapping description is omitted. Note also that the detailed operations of the response output unit 100 in the equipment control device 1 according to the second embodiment are the same as the detailed operations of the response output unit 100 which are described using FIG. 8 in the first embodiment, and thus, an overlapping description is omitted.

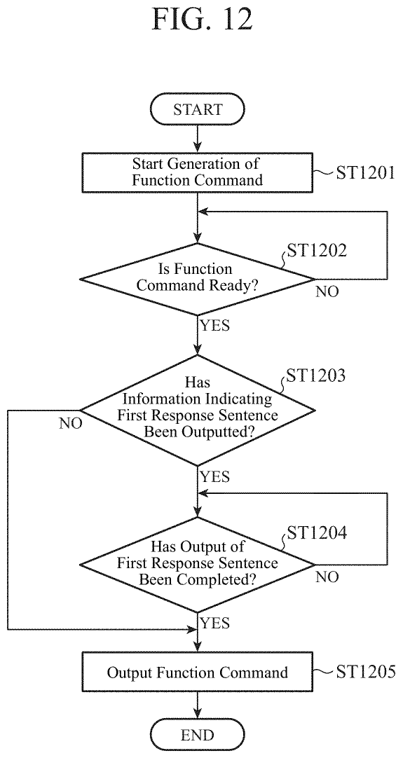

FIG. 12 is a flowchart for specifically describing the operations of the command control unit 200 in the equipment control device 1 according to the second embodiment.

Specific operations at steps ST1201 to ST1202 and ST1205 of FIG. 12 are the same as specific operations at steps ST901 to ST902 and ST905 of FIG. 9 which are described in the first embodiment, respectively, and thus, an overlapping description is omitted.

If a function command is ready by the function command generating unit 201 at step ST1202 (if “YES” at step ST1202), then the function command output unit 202 determines whether or not the output control unit 105 has already outputted information indicating a first response sentence to the voice output device 42 (step ST1203).

If the function command output unit 202 has determined at step ST1203 that the output control unit 105 has not yet outputted information indicating a first response sentence (if “NO” at step 1203), then the equipment control device 1 proceeds to a process at step ST1205.

If the function command output unit 202 has determined at step ST1203 that the output control unit 105 has already outputted information indicating a first response sentence (if “YES” at step ST1203), then the function command output unit 202 determines whether or not the voice output device 42 has completed output, by voice, of the first response sentence based on the information indicating a first response sentence (step ST1204).

If it is determined at step ST1204 that the output of the first response sentence by voice has not been completed (if “NO” at step ST1204), then the function command output unit 202 waits until the output of the first response sentence by voice has been completed, and suspends output of the function command.

If it is determined at step ST1204 that the output of the first response sentence by voice has been completed (if “YES” at step ST1204), then the function command output unit 202 outputs the function command (step ST1205).

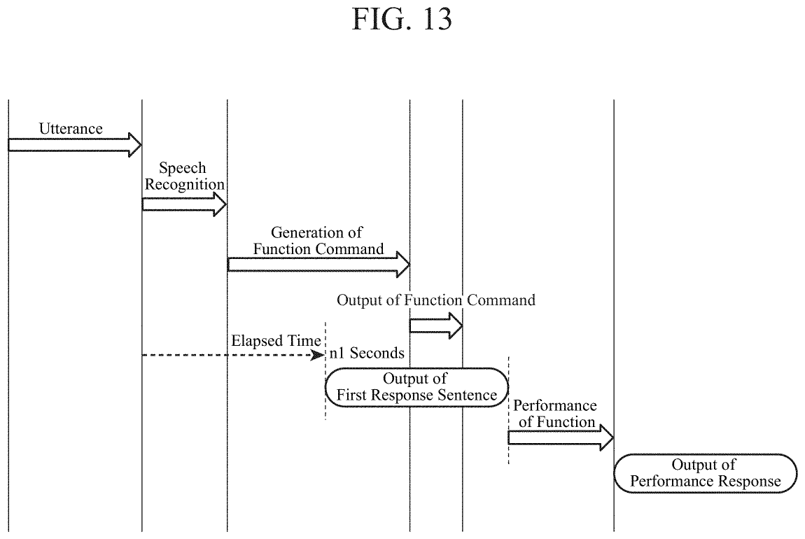

FIG. 13 is a diagram showing an outline of the flow of time when the equipment control device 1 according to the second embodiment has performed the operations described in FIGS. 8 and 12 and suspended output of a function command until output of a first response sentence by voice is completed.

When the equipment control device 1 has outputted information indicating a first response sentence, the voice output device 42 outputs the first response sentence by voice. In this case, if a target function is performed by target equipment before completion of the output of the first response sentence by voice, and a performance response is outputted from the equipment control device 1, then there is a possibility that, for example, the output of the first response sentence by voice is interrupted on the voice output device 42.

In consideration of this, in the equipment control device 1 according to the second embodiment, upon outputting a function command, when information indicating a first response sentence is outputted to the voice output device 42 before outputting the function command and the voice output device 42 has not completed output, by voice, of the first response sentence based on the information indicating a first response sentence, output of the function command is suspended until the output of the first response sentence by voice has been completed. As a result, when the equipment control device 1 causes the voice output device 42 to output a first response sentence by voice, the equipment control device 1 can prevent interruption of the output of the first response sentence by voice.

As described above, according to the second embodiment, the equipment control device 1 is configured in such a manner that when the function command generating unit 201 has completed generation of a function command after the output control unit 105 outputs information indicating a first response sentence, if output, by voice, of the first response sentence based on the information indicating a first response sentence which is outputted from the output control unit 105 has not been completed, then the function command output unit 202 suspends output of the function command until the output of the first response sentence by voice has been completed. Hence, the equipment control device 1 can prevent interruption of output of a first response sentence by voice which is outputted when time from utterance to performance of a function by equipment is long.

### Third Embodiment

In the first embodiment, the equipment control device 1 measures first elapsed time until a function command is outputted to target equipment, and outputs information indicating a first response sentence when the first elapsed time has exceeded first target time.

In a third embodiment, an embodiment will be described in which an equipment control device 1 measures elapsed time from a speech obtained time, until performance of a target function by target equipment is completed on the basis of a function command, and outputs information indicating a first response sentence when the elapsed time has exceeded preset time.

The configuration of an equipment control system 1000 including the equipment control device 1 according to the third embodiment is the same as the configuration of the equipment control system 1000 described using FIG. 1 in the first embodiment, and thus, an overlapping description is omitted.

In addition, the configuration of the equipment control device 1 according to the third embodiment is the same as the configuration described using FIGS. 2 to 4 in the first embodiment, and thus, an overlapping description is omitted.

Note that in the equipment control device 1 according to the third embodiment, the operations of a time measuring unit 102, a time determining unit 103, a performance notification accepting unit 107, and a function command output unit 202 differ from the operations of the time measuring unit 102, the time determining unit 103, the performance notification accepting unit 107, and the function command output unit 202 in the equipment control device 1 according to the first embodiment.

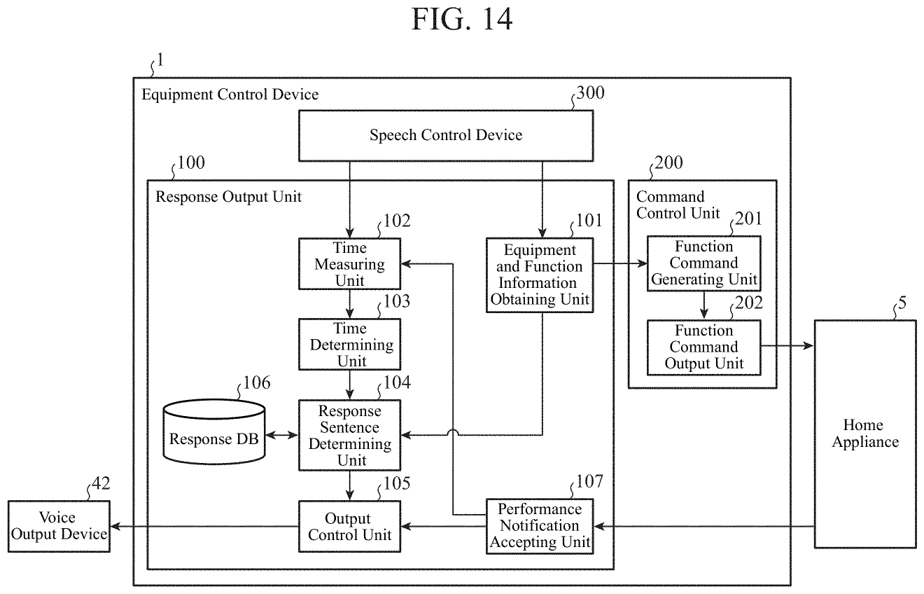

FIG. 14 is a diagram showing an exemplary configuration of the equipment control device 1 according to the third embodiment.

As shown in FIG. 14, when the performance notification accepting unit 107 accepts a performance completion notification from the home appliance 5 which is target equipment, the performance notification accepting unit 107 outputs information indicating that the performance completion notification has been accepted, to the output control unit 105 and also to the time measuring unit 102.

The function command output unit 202 does not need to output information indicating that a function command has been outputted to the target equipment, to the time measuring unit 102.

The time measuring unit 102 measures elapsed time from a speech obtained time (hereinafter, referred to as “second elapsed time”.). The speech obtained time is already described in the first embodiment and thus a detailed description thereof is omitted.

In the third embodiment, the time measuring unit 102 continues measuring the second elapsed time until the performance notification accepting unit 107 accepts a performance completion notification from the target equipment. The time measuring unit 102 can obtain information indicating that the performance notification accepting unit 107 has accepted a performance completion notification from the target equipment, from the performance notification accepting unit 107. When the time measuring unit 102 obtains information indicating that a performance completion notification has been accepted, from the performance notification accepting unit 107, the time measuring unit 102 ends the measurement of the second elapsed time.

The time measuring unit 102 continuously outputs the second elapsed time to the time determining unit 103. When the time measuring unit 102 has obtained information indicating that a performance completion notification has been accepted, from the performance notification accepting unit 107, the time measuring unit 102 stops the output of the second elapsed time.

The time determining unit 103 determines whether or not required performance time is long. Specifically, the time determining unit 103 determines whether or not the second elapsed time obtained from the time measuring unit 102 has exceeded preset time (hereinafter, referred to as “second target time”.). As the second target time, for example, time is preset that is somewhat shorter than time estimated to cause the user to feel that “he or she is kept waiting” when there is no response from the target equipment, etc., during a period from utterance to performance of a target function. Although in the third embodiment, the second target time is assumed to be longer than the first target time, the second target time may be the same length of time as the first target time.

The time determining unit 103 makes the above-described determination, for example, every time second elapsed time is outputted from the time measuring unit 102.

When the second elapsed time has exceeded the second target time, the time determining unit 103 determines that the required performance time is long. As described above, when the time measuring unit 102 has obtained information indicating that a performance completion notification has been accepted, from the performance notification accepting unit 107, the time measuring unit 102 ends the measurement of the second elapsed time. A state in which the second elapsed time has exceeded the second target time indicates a state in which the second target time has already elapsed during a period from when uttered speech is obtained to when the performance notification accepting unit 107 accepts a performance completion notification from the target equipment. For example, in order not to make the user feel that “he or she is kept waiting”, there is a need to promptly output a first response sentence from the voice output device 42, etc., after the above-described state has been determined.

On the other hand, when the second elapsed time has not exceeded the second target time, the time determining unit 103 determines that the required performance time is not long. A state in which the second elapsed time has not exceeded the second target time indicates a state in which the second target time has not yet elapsed during a period from when uttered speech is obtained to when the performance notification accepting unit 107 accepts a performance completion notification from the target equipment.

When the time determining unit 103 determines that the required performance time is long, the time determining unit 103 outputs information indicating that the required performance time is determined to be long (hereinafter, referred to as “function performance delay information”.) to the response sentence determining unit 104.

The operations of the response output unit 100 in the equipment control device 1 according to the third embodiment will be described in detail.

Note that the basic operations of the equipment control device 1 according to the third embodiment are the same as the basic operations of the equipment control device 1 which are described using the flowchart of FIG. 7 in the first embodiment, and thus, an overlapping description is omitted. Note also that the detailed operations of the command control unit 200 in the equipment control device 1 according to the third embodiment are the same as the detailed operations of the command control unit 200 which are described using FIG. 9 in the first embodiment, and thus, an overlapping description is omitted.

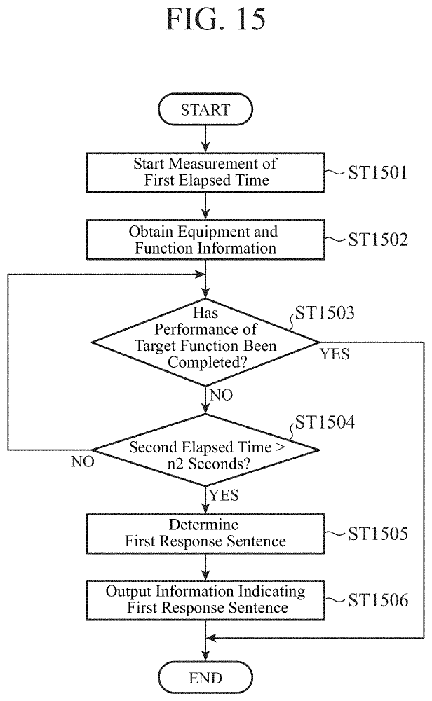

FIG. 15 is a flowchart for specifically describing the operations of the response output unit 100 in the equipment control device 1 according to the third embodiment. Note that in the following description of the operations using FIG. 15, as an example, second target time which the time determining unit 103 compares with second elapsed time is “n2 seconds”.

Specific operations at steps ST1501 to ST1502 and ST1505 to ST1506 of FIG. 15 are the same as specific operations at steps ST801 to ST802 and ST805 to ST806 of FIG. 8 which are described in the first embodiment, respectively, and thus, an overlapping description is omitted.

The time measuring unit 102 determines whether or not target equipment has completed performance of a target function (step ST1503). Specifically, the time measuring unit 102 determines whether or not information indicating that a performance completion notification has been accepted has been obtained from the performance notification accepting unit 107.

If the time measuring unit 102 has determined at step ST1503 that the target equipment has completed performance of the target function (if “YES” at step ST1503), then the time measuring unit 102 ends the measurement of second elapsed time, and the response output unit 100 ends the process. Note that the response output unit 100 ends the process after the performance notification accepting unit 107 accepts a performance completion notification transmitted from the target equipment and the output control unit 105 outputs information indicating a performance response.

If the time measuring unit 102 has determined at step ST1503 that the target equipment has not yet completed performance of the target function (if “NO” at step ST1503), then the time determining unit 103 determines whether or not the second elapsed time has exceeded n2 seconds (step ST1504).

If the time determining unit 103 has determined at step ST1504 that the second elapsed time has not exceeded n2 seconds (if “NO” at step ST1504), then the time determining unit 103 determines that required performance time is not long, and returns to step ST1503.

If the time determining unit 103 has determined at step ST1504 that the second elapsed time has exceeded n2 seconds (if “YES” at step ST1504), then the time determining unit 103 determines that the required performance time is long, and outputs function performance delay information to the response sentence determining unit 104.

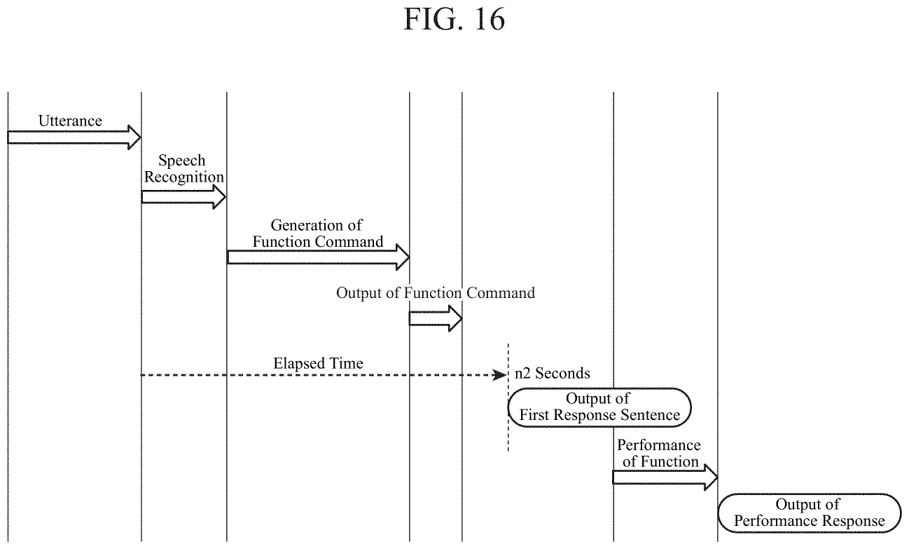

FIG. 16 is a diagram showing an outline of the flow of time up to the time when a first response sentence is outputted by voice from the voice output device 42 in a case where the equipment control device 1 according to the third embodiment has performed the operations described in FIGS. 15 and 9 and determined that required performance time is long.

As described above, when second elapsed time has exceeded second target time, the equipment control device 1 outputs information indicating a first response sentence. Namely, in the equipment control device 1, when the second target time has elapsed during a period from when uttered speech is obtained to when the performance notification accepting unit 107 accepts a performance completion notification, the time determining unit 103 determines that required performance time is long, and the output control unit 105 outputs information indicating a first response sentence determined by the response sentence determining unit 104 to the voice output device 42.

In the equipment control device 1, in addition to the fact that it takes time for the function command generating unit 201 to generate a function command, for example, it may take time for the equipment control device 1 to accept a performance completion notification from target equipment after outputting a function command, due to a network environment, the processing capability of the target equipment, or the like. For this reason, too, there is a case in which required performance time is long. In that case, there is a possibility that the user feels that waiting time until a target function instructed by utterance is performed by target equipment is long.

In consideration of this, in the equipment control device 1, as described above, when the second target time has elapsed during a period from when uttered speech is obtained to when the performance notification accepting unit 107 accepts a performance completion notification from target equipment, the time determining unit 103 determines that required performance time is long, and the output control unit 105 outputs a first response sentence determined by the response sentence determining unit 104 to the voice output device 42.

As a result, even when the required performance time is long in a case where an instruction for performance of a target function by target equipment is given by the user making an utterance, during that period of time, the user can recognize whether or not the intended function is going to be performed by the equipment.

As described above, according to the third embodiment, in the equipment control device 1, when second elapsed time measured by the time measuring unit 102 has exceeded second target time, the time determining unit 103 determines that time from utterance to performance of a target function is long. Hence, as in the first embodiment, in a technique in which equipment is controlled on the basis of a result of speech recognition performed for user's uttered speech, even when time from utterance to performance of a function by the equipment is long, during that period of time, the user can recognize whether or not the intended function is going to be performed by the equipment.

### Fourth Embodiment

In the first embodiment, in the equipment control device 1, information which indicates a response sentence related to a target function and which is outputted when required performance time is determined to be long is only information indicating a first response sentence.

In a fourth embodiment, an embodiment will be described in which an equipment control device 1a outputs information indicating a first response sentence when required performance time is determined to be long, and outputs information indicating a new response sentence (hereinafter, referred to as a “second response sentence”.) when elapsed time from the output of the information indicating a first response sentence is long.

The configuration of an equipment control system 1000 including the equipment control device 1a according to the fourth embodiment is the same as the configuration of the equipment control system 1000 described using FIG. 1 in the first embodiment, and thus, an overlapping description is omitted.

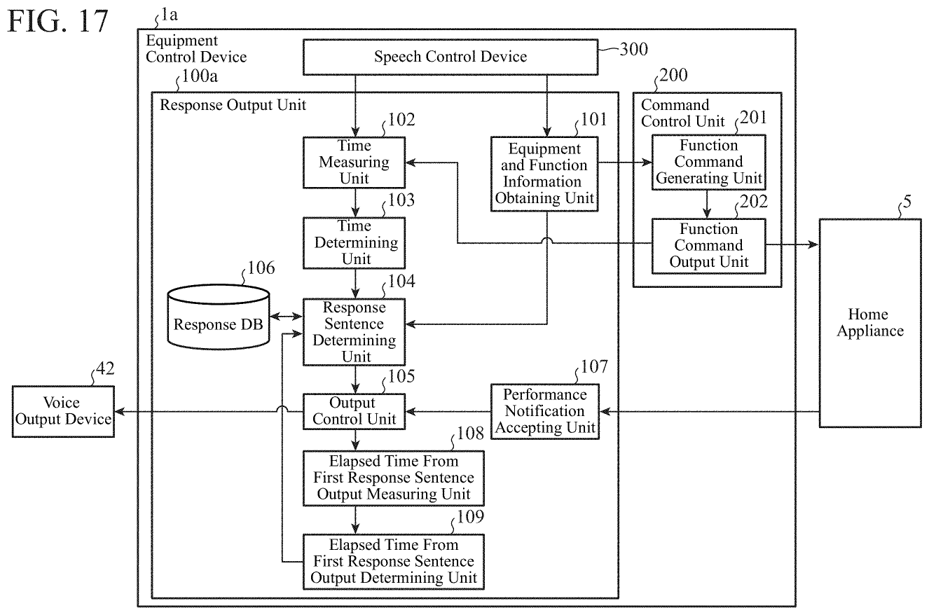

FIG. 17 is a diagram showing an exemplary configuration of the equipment control device 1a according to the fourth embodiment. Note that an exemplary schematic configuration of the equipment control device 1a and an exemplary configuration of the speech control device 300 in the equipment control device 1a are the same as an exemplary schematic configuration of the equipment control device 1 and an exemplary configuration of the speech control device 300 in the equipment control device 1 which are described using FIGS. 2 and 3 in the first embodiment, and thus, an overlapping description is omitted.

In FIG. 17, the same components as those of the equipment control device 1 according to the first embodiment which are described using FIG. 4 in the first embodiment are given the same reference signs, and an overlapping description thereof is omitted.

The equipment control device 1a according to the fourth embodiment differs from the equipment control device 1 according to the first embodiment in that a response output unit 100a includes an elapsed time from first response sentence output measuring unit 108 and an elapsed time from first response sentence output determining unit 109.

The elapsed time from first response sentence output measuring unit 108 measures elapsed time from when the output control unit 105 outputs information indicating a first response sentence to the present (hereinafter, referred to as “elapsed time from first response sentence output”.).

The elapsed time from first response sentence output measuring unit 108 outputs information indicating the measured elapsed time from first response sentence output to the elapsed time from first response sentence output determining unit 109. Note that the elapsed time from first response sentence output measuring unit 108 continuously outputs the elapsed time from first response sentence output to the elapsed time from first response sentence output determining unit 109.

The elapsed time from first response sentence output determining unit 109 determines whether or not the elapsed time from first response sentence output which is obtained from the elapsed time from first response sentence output measuring unit 108 has exceeded preset time (hereinafter, referred to as “third target time”.).

The elapsed time from first response sentence output determining unit 109 determines whether or not time elapsed from the output of the information indicating a first response sentence is long, on the basis of whether or not the elapsed time from first response sentence output which is obtained from the elapsed time from first response sentence output measuring unit 108 has exceeded the third target time. As the third target time, time is preset that is somewhat shorter than time estimated to cause the user to feel that “he or she is kept waiting” when the time has elapsed after output of the first response sentence. The third target time may be the same length of time as the first target time or the second target time.

The elapsed time from first response sentence output determining unit 109 makes the above-described determination, for example, every time elapsed time from first response sentence output is outputted from the elapsed time from first response sentence output measuring unit 108.

A state in which the elapsed time from first response sentence output has exceeded the third target time indicates a state in which the third target time has elapsed from when information indicating a first response sentence is outputted from the output control unit 105. For example, in order not to make the user feel that “he or she is kept waiting”, there is a need to promptly output a second response sentence from the voice output device 42, etc., after the above-described state has been determined.

When the elapsed time from first response sentence output determining unit 109 has determined that time elapsed from output of information indicating a first response sentence is long, the elapsed time from first response sentence output determining unit 109 outputs information indicating that the time elapsed from output of information indicating a first response sentence is determined to be long (hereinafter, referred to as “time excess after response information”.) to the response sentence determining unit 104.

Note that when the elapsed time from first response sentence output determining unit 109 has determined that the elapsed time from first response sentence output has not exceeded the third target time, the elapsed time from first response sentence output determining unit 109 determines that the time elapsed from output of information indicating a first response sentence is not long, and does not output the time excess after response information.

When the time determining unit 103 has determined that required performance time is long, the response sentence determining unit 104 determines a first response sentence, and when the elapsed time from first response sentence output determining unit 109 has determined that the elapsed time from first response sentence output has exceeded the third target time, the response sentence determining unit 104 determines a second response sentence. A method of determining a first response sentence by the response sentence determining unit 104 is already described in the first embodiment, and thus, an overlapping description is omitted.

The response sentence determining unit 104 determines a second response sentence on the basis of second response sentence information which is generated in advance and stored in the response DB 106. In the fourth embodiment, response sentence information referred to by the response sentence determining unit 104 upon determining a second response sentence is referred to as “second response sentence information”.

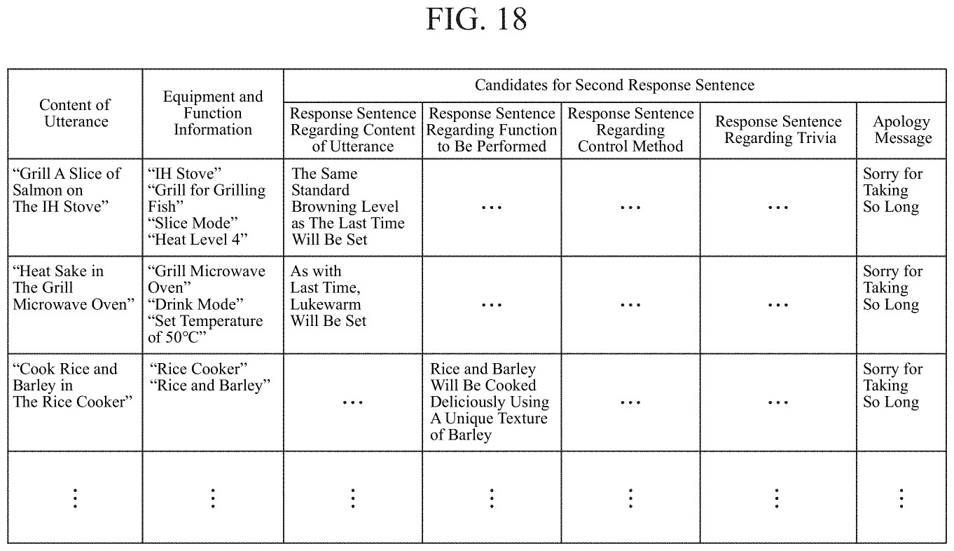

Here, FIG. 18 is a diagram for describing examples of the content of second response sentence information referred to by the response sentence determining unit 104 upon determining a second response sentence in the fourth embodiment.

The second response sentence information is information in which equipment and function information and candidates for a second response sentence that can become a second response sentence are defined in such a manner as to be associated with each other. Note that in FIG. 18, for easy understanding, the content of user's utterance (see the “content of utterance” field in FIG. 18) is shown in such a manner as to be associated with equipment and function information. As shown in FIG. 18, in the second response sentence information, for example, one piece of equipment and function information can be associated with a response sentence regarding the content of utterance, a response sentence regarding a function to be performed, a response sentence regarding a control method, a response sentence regarding trivia, and an apology message which are candidates for a second response sentence.

The response sentence determining unit 104 determines a second response sentence from candidates for a second response sentence which are associated with, in the second response sentence information, equipment and function information obtained by the equipment and function information obtaining unit 101. The response sentence determining unit 104 may determine the second response sentence by a method according to the situation. Note that it is preferred that when the second response sentence is not an apology message such as “Sorry for taking so long”, the response sentence determining unit 104 determine a candidate for a second response sentence whose content corresponds to an outputted first response sentence, to be a second response sentence. The outputted first response sentence referred to here is a first response sentence that is identified using information indicating the first response sentence whose elapsed time from first response sentence output is determined by the elapsed time from first response sentence output determining unit 109 to have exceeded the third target time. The response sentence determining unit 104 may obtain information indicating the outputted first response sentence, for example, from the output control unit 105 through the elapsed time from first response sentence output measuring unit 108 and the elapsed time from first response sentence output determining unit 109. In addition, the response sentence determining unit 104 may identify a candidate for a second response sentence corresponding to the first response sentence by comparing the second response sentence information with the first response sentence information described using FIG. 5.

A specific example is as follows. For example, it is assumed that the response sentence determining unit 104 has determined, on the basis of response sentence information such as that shown in FIG. 5, that “Preparing for slice mode right now” is a first response sentence, and thereby the output control unit 105 has outputted information indicating the “Preparing for slice mode right now”. Then, it is assumed that third target time has elapsed from when the output control unit 105 has outputted the information indicating the “Preparing for slice mode right now”. In this case, the response sentence determining unit 104 determines that “The same standard browning level as the last time will be set” which is a response sentence regarding the content of utterance which is the same as “Preparing for slice mode right now” is a second response sentence, on the basis of second response sentence information such as that shown in FIG. 18.

Note that although here the response DB 106 separately stores first response sentence information such as that shown in FIG. 5 and second response sentence information such as that shown in FIG. 18, this is merely an example. The content of second response sentence information may be included in first response sentence information, and the first response sentence information may be stored in the response DB 106, as one piece of response sentence information. In this case, the response sentence determining unit 104 may determine a second response sentence on the basis of the one piece of response sentence information.

In addition, the content of second response sentence information shown in FIG. 18 is merely an example. In second response sentence information, one piece of equipment and function information may be associated with only one candidate for a second response sentence, or a candidate for a second response sentence may be a response sentence other than a response sentence regarding the content of utterance, a response sentence regarding a function to be performed, a response sentence regarding a control method, a response sentence regarding trivia, and an apology message. Second response sentence information may be configured in any manner as long as the second response sentence information defines one or more second response sentences related to target equipment or an apology message, as candidates for a second response sentence which correspond to one piece of equipment and function information. In addition, when a result of speech recognition is included in equipment and function information, second response sentence information stored in the response DB 106 may include information in which the result of speech recognition and candidates for a second response sentence that can become a second response sentence are defined in such a manner as to be associated with each other. In that case, the response sentence determining unit 104 can determine a second response sentence also from the candidates for a second response sentence associated with the result of speech recognition.

The response sentence determining unit 104 outputs information indicating the determined second response sentence to the output control unit 105.

When the information indicating the second response sentence is outputted from the response sentence determining unit 104, the output control unit 105 outputs the information indicating the second response sentence to the voice output device 42.

When the information indicating the second response sentence is outputted from the output control unit 105, the voice output device 42 outputs the second response sentence by voice in accordance with the information indicating the second response sentence.

Note that the output control unit 105 performs output of information indicating a first response sentence and output of information indicating a performance response which are already described in the first embodiment, in addition to the above-described output of information indicating a second response sentence.

The operations of the response output unit 100a in the equipment control device 1a according to the fourth embodiment will be described in detail.

Note that the basic operations of the equipment control device 1a according to the fourth embodiment are the same as the basic operations of the equipment control device 1 which are described using the flowchart of FIG. 7 in the first embodiment, and thus, an overlapping description is omitted. Note also that the detailed operations of the command control unit 200 in the equipment control device 1a according to the fourth embodiment are the same as the detailed operations of the command control unit 200 which are described using FIG. 9 in the first embodiment, and thus, an overlapping description is omitted.

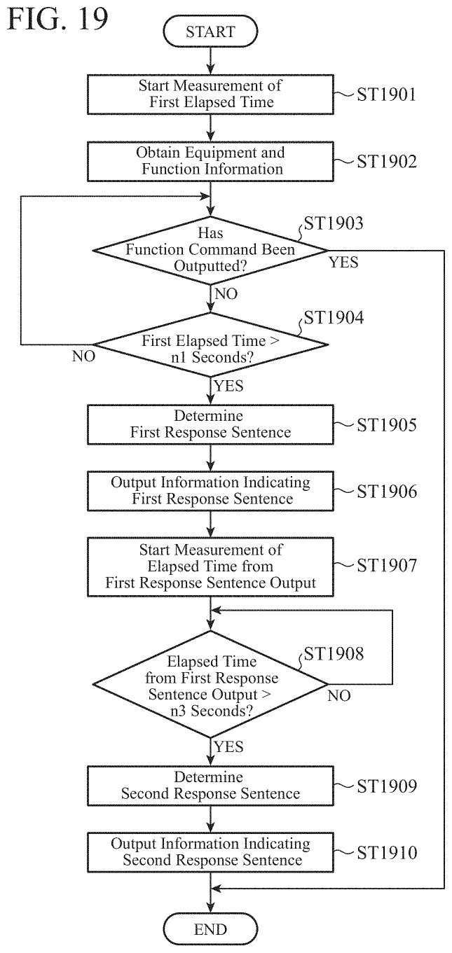

FIG. 19 is a flowchart for describing the detailed operations of the response output unit 100a in the equipment control device 1a according to the fourth embodiment. Note that in the following description of the operations using FIG. 19, as an example, third target time which the elapsed time from first response sentence output determining unit 109 compares with elapsed time from first response sentence output is “n3 seconds”.

Specific operations at steps ST1901 to ST1906 of FIG. 19 are the same as specific operations at steps ST801 to ST806 of FIG. 8 which are described in the first embodiment, respectively, and thus, an overlapping description is omitted.

When the output control unit 105 outputs information indicating a first response sentence at step ST1906, the elapsed time from first response sentence output measuring unit 108 starts measurement of elapsed time from first response sentence output (step ST1907).

The elapsed time from first response sentence output determining unit 109 determines whether or not the elapsed time from first response sentence output has exceeded n3 seconds (step ST1908).

If the elapsed time from first response sentence output determining unit 109 has determined at step ST1908 that the elapsed time from first response sentence output has not exceeded n3 seconds (if “NO” at step ST1908), then the elapsed time from first response sentence output determining unit 109 repeats the process at step ST1908.

If the elapsed time from first response sentence output determining unit 109 has determined at step ST1908 that the elapsed time from first response sentence output has exceeded n3 seconds (if “YES” at step ST1908), then the elapsed time from first response sentence output determining unit 109 determines that time elapsed from when the information indicating a first response sentence is outputted is long, and outputs time excess after response information to the response sentence determining unit 104.

When the time excess after response information is outputted from the elapsed time from first response sentence output determining unit 109 at step ST1908, the response sentence determining unit 104 determines a second response sentence (step ST1909).

The response sentence determining unit 104 outputs information indicating the determined second response sentence to the output control unit 105.

The output control unit 105 outputs the information indicating the second response sentence determined by the response sentence determining unit 104 at step ST1909 to the voice output device 42 (step ST1910).

The voice output device 42 outputs the second response sentence by voice in accordance with the information which indicates the second response sentence and which is outputted from the output control unit 105.

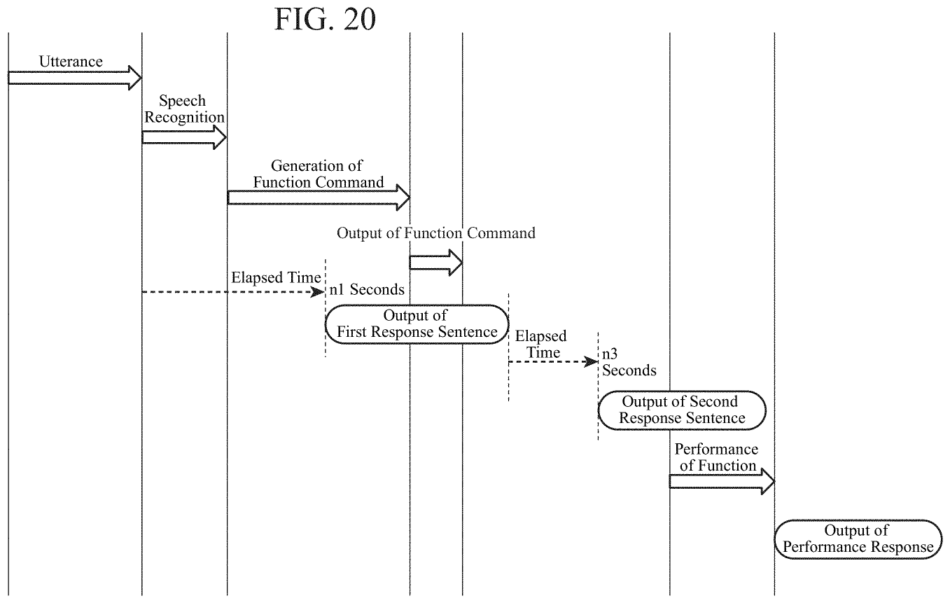

FIG. 20 is a diagram showing an outline of the flow of time up to the time when a second response sentence is outputted by voice from the voice output device 42 in a case where the equipment control device 1a according to the fourth embodiment has performed the operations described in FIGS. 19 and 9 and determined that time elapsed from when information indicating a first response sentence is outputted is long.

As described above, when elapsed time from first response sentence output has exceeded third target time, the equipment control device 1a outputs information indicating a second response sentence. Namely, in the equipment control device 1a, when the third target time has elapsed from output of information indicating a first response sentence, the elapsed time from first response sentence output determining unit 109 determines that time elapsed from when the information indicating a first response sentence is outputted is long, and the output control unit 105 outputs information indicating a second response sentence determined by the response sentence determining unit 104 to the voice output device 42.

As a result, when it is estimated that the user still feels that “he or she is kept waiting” even after output of a first response sentence, a second response sentence is outputted by voice from the voice output device 42, and thus the equipment control device 1a can further reduce a possibility that the user feels that “he or she is kept waiting”, compared to a case in which only a first response sentence is outputted by voice.

As described above, according to the fourth embodiment, the equipment control device 1a is configured in such a manner that the equipment control device 1a includes the elapsed time from first response sentence output measuring unit 108 that measures elapsed time from first response sentence output that has elapsed from when information indicating a first response sentence is outputted from the output control unit 105; and the elapsed time from first response sentence output determining unit 109 that determines whether or not the elapsed time from first response sentence output measured by the elapsed time from first response sentence output measuring unit 108 has exceeded third target time, and when the elapsed time from first response sentence output determining unit 109 has determined that the elapsed time from first response sentence output has exceeded the third target time, the response sentence determining unit 104 determines a second response sentence, and the output control unit 105 outputs information indicating the second response sentence determined by the response sentence determining unit 104, in addition to the information indicating a first response sentence. Hence, the equipment control device 1a can further reduce a possibility that the user feels that “he or she is kept waiting”, compared to a case in which only information indicating a first response sentence is outputted.

### Fifth Embodiment

In the first embodiment, a function of measuring first elapsed time is provided, and it is determined whether or not required performance time is long, on the basis of whether or not the first elapsed time has exceeded first target time.

In a fifth embodiment, an embodiment will be described in which a function of predicting elapsed time from a speech obtained time to output of a function command to target equipment is provided, and it is determined whether or not required performance time is long, on the basis of the predicted elapsed time.

The configuration of an equipment control system 1000 including an equipment control device 1b according to the fifth embodiment is the same as the configuration of the equipment control system 1000 described using FIG. 1 in the first embodiment, and thus, an overlapping description is omitted.

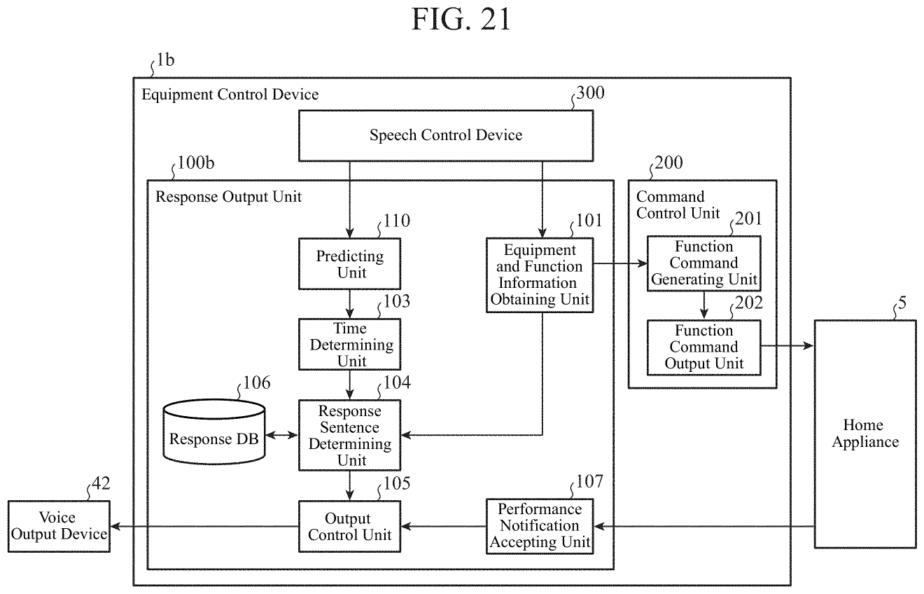

FIG. 21 is a diagram showing an exemplary configuration of the equipment control device 1b according to the fifth embodiment. Note that an exemplary schematic configuration of the equipment control device 1b and an exemplary configuration of the speech control device 300 in the equipment control device 1b are the same as an exemplary schematic configuration of the equipment control device 1 and an exemplary configuration of the speech control device 300 in the equipment control device 1 which are described using FIGS. 2 and 3 in the first embodiment, and thus, an overlapping description is omitted.

In FIG. 21, the same components as those of the equipment control device 1 according to the first embodiment are given the same reference signs, and an overlapping description thereof is omitted.

The equipment control device 1b according to the fifth embodiment differs from the equipment control device 1 according to the first embodiment in that a response output unit 100b includes a predicting unit 110 instead of the time measuring unit 102.

Note that in the fifth embodiment, the speech obtaining unit 301 in the speech control device 300 outputs obtained uttered speech to the predicting unit 110.

The predicting unit 110 predicts elapsed time from a speech obtained time to performance of a target function. Specifically, the predicting unit 110 predicts elapsed time from a speech obtained time to output of a function command from the function command output unit 202 (hereinafter, referred to as “first predicted elapsed time”.). The speech obtained time is already described in the first embodiment and thus an overlapping description thereof is omitted.

The predicting unit 110 can obtain a speech obtained time from the speech obtaining unit 301. For example, the speech obtaining unit 301 adds information indicating a speech obtained time to uttered speech, and outputs the uttered speech with the information to the predicting unit 110.

In addition, in the fifth embodiment, the speech obtained time may be a time at which the predicting unit 110 has obtained uttered speech from the speech obtaining unit 301.

For example, it is assumed that the storage unit stores, for each uttered speech and as a history, a record of time taken from a speech obtained time to output of a function command from the function command output unit 202 in the past.

The predicting unit 110 predicts first predicted elapsed time on the basis of the uttered speech obtained from the speech obtaining unit 301, the speech obtained time, and the history stored in the storage unit.

The predicting unit 110 outputs information indicating the predicted first predicted elapsed time to the time determining unit 103.

The time determining unit 103 determines whether or not required performance time is long. Specifically, the time determining unit 103 determines whether or not the information indicating the first predicted elapsed time obtained from the predicting unit 110 exceeds preset time (hereinafter, referred to as “fourth target time”.). As the fourth target time, for example, time is preset that is somewhat shorter than time estimated to cause the user to feel that “he or she is kept waiting” when there is no response from target equipment, etc., during a period from utterance to performance of a target function.

When the first predicted elapsed time exceeds the fourth target time, the time determining unit 103 determines that the required performance time is long. A state in which the first predicted elapsed time exceeds the fourth target time indicates a state in which it is predicted that the fourth target time elapses during a period from when uttered speech is obtained to when the function command output unit 202 outputs a function command to the target equipment. For example, in order not to make the user feel that “he or she is kept waiting”, there is a need to promptly output a first response sentence from the voice output device 42, etc., after the above-described state has been determined.

On the other hand, when the first predicted elapsed time does not exceed the fourth target time, the time determining unit 103 determines that the required performance time is not long. A state in which the first predicted elapsed time does not exceed the fourth target time indicates a state in which it is predicted that the fourth target time does not elapse during a period from when uttered speech is obtained to when the function command output unit 202 outputs a function command to the target equipment.

When the time determining unit 103 has determined that the required performance time is long, the time determining unit 103 outputs function performance delay information to the response sentence determining unit 104.

When the time determining unit 103 has determined that the required performance time is long, the response sentence determining unit 104 determines a first response sentence with a length corresponding to the first predicted elapsed time predicted by the predicting unit 110, on the basis of equipment and function information obtained by the equipment and function information obtaining unit 101.

The response sentence determining unit 104 determines a first response sentence on the basis of first response sentence information which is generated in advance and stored in the response DB 106. In the fifth embodiment, the content of first response sentence information stored in the response DB 106 differs from the content of first response sentence information (see FIG. 5) stored in the response DB 106 in the first embodiment.

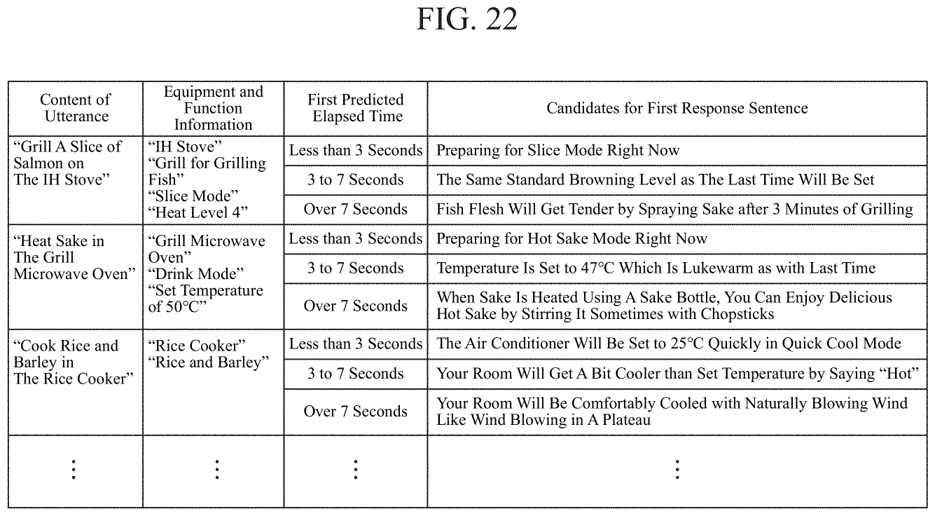

Here, FIG. 22 is a diagram for describing examples of the content of first response sentence information referred to by the response sentence determining unit 104 upon determining a first response sentence in the fifth embodiment.

In the fifth embodiment, first response sentence information is information in which equipment and function information and candidates for a first response sentence that can become a first response sentence are defined in such a manner as to be associated with each other, and the candidates for a first response sentence are each defined for the corresponding first predicted elapsed time. Note that in FIG. 22, for easy understanding, the content of user's utterance (see the “content of utterance” field in FIG. 22) is shown in such a manner as to be associated with equipment and function information. As shown in FIG. 22, in the first response sentence information, for example, one piece of equipment and function information can be associated with a response sentence regarding the content of utterance, a response sentence regarding a function to be performed, a response sentence regarding a control method, or a response sentence regarding trivia which is a candidate for a first response sentence.

The response sentence determining unit 104 determines a first response sentence corresponding to first predicted elapsed time from candidates for a first response sentence which are associated with, in the first response sentence information, equipment and function information obtained by the equipment and function information obtaining unit 101. The response sentence determining unit 104 may determine a candidate for a first response sentence which becomes a first response sentence by any method, as long as the candidate is associated with the equipment and function information and corresponds to the first predicted elapsed time.

For example, when the equipment and function information obtained by the equipment and function information obtaining unit 101 is information in which information of “IH stove” is associated with information of “grill for grilling fish”, “slice mode”, and “heat level 4”, and the first predicted elapsed time predicted by the predicting unit 110 is 5 seconds, the response sentence determining unit 104 determines that “The same standard browning level as the last time will be set” is a first response sentence.

Note that here, as in the above-described example, for example, when the first predicted elapsed time is 5 seconds, the response sentence determining unit 104 determines that a candidate for a first response sentence associated with the first predicted elapsed time “3 to 7 seconds” in first response sentence information is a first response sentence. However, this is merely an example. For example, when the first predicted elapsed time is 5 seconds, the response sentence determining unit 104 may use a candidate for a first response sentence associated with the first predicted elapsed time “less than 3 seconds” in the first response sentence information, together with a candidate for a first response sentence associated with “3 to 7 seconds” in the first response sentence information, as a candidate for a first response sentence. Namely, in the above-described example, the response sentence determining unit 104 may determine that “Preparing for slice mode right now. The same standard browning level as the last time will be set” is a first response sentence.

In addition, the content of first response sentence information shown in FIG. 22 is merely an example. In first response sentence information, one piece of equipment and function information may be associated with only one candidate for a first response sentence, or a candidate for a first response sentence may be a response sentence other than a response sentence regarding the content of utterance, a response sentence regarding a function to be performed, a response sentence regarding a control method, and a response sentence regarding trivia. First response sentence information may be configured in any manner as long as the first response sentence information defines one or more first response sentences related to target equipment, as candidates for a first response sentence which correspond to one piece of equipment and function information. In addition, when a result of speech recognition is included in equipment and function information, first response sentence information stored in the response DB 106 may include information in which the result of speech recognition and candidates for a first response sentence that can become a first response sentence are defined in such a manner as to be associated with each other. In that case, the response sentence determining unit 104 can determine a first response sentence also from the candidates for a first response sentence associated with the result of speech recognition.

The response sentence determining unit 104 outputs information indicating the determined first response sentence to the output control unit 105.

The operations of the response output unit 100b in the equipment control device 1b according to the fifth embodiment will be described in detail.

Note that the basic operations of the equipment control device 1b according to the fifth embodiment are the same as the basic operations of the equipment control device 1 which are described using the flowchart of FIG. 7 in the first embodiment, and thus, an overlapping description is omitted. Note also that the detailed operations of the command control unit 200 in the equipment control device 1b according to the fifth embodiment are the same as the detailed operations of the command control unit 200 which are described using FIG. 9 in the first embodiment, and thus, an overlapping description is omitted.

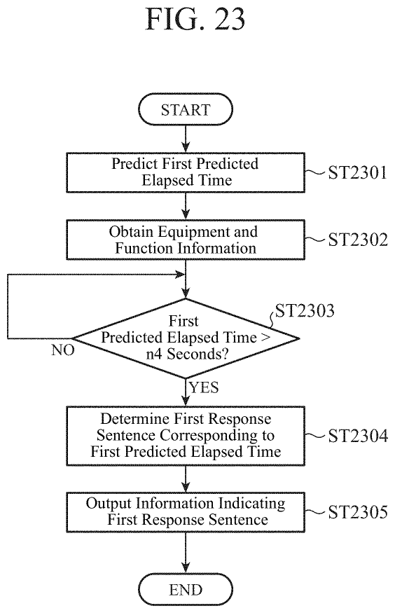

FIG. 23 is a flowchart for describing the detailed operations of the response output unit 100b in the equipment control device 1b according to the fifth embodiment. Note that in the following description of the operations using FIG. 23, as an example, fourth target time which the time determining unit 103 compares with first predicted elapsed time is “n4 seconds”.

Specific operations at steps ST2302 and ST2305 of FIG. 23 are the same as specific operations at steps ST802 and ST806 of FIG. 8 which are described in the first embodiment, respectively, and thus, an overlapping description is omitted.

The predicting unit 110 predicts first predicted elapsed time (step ST2301).

The predicting unit 110 outputs information indicating the predicted first predicted elapsed time to the time determining unit 103.

The time determining unit 103 determines whether or not the first predicted elapsed time exceeds n4 seconds (step ST2303).

If the time determining unit 103 determines at step ST2303 that the first predicted elapsed time does not exceed n4 seconds (if “NO” at step ST2303), then the time determining unit 103 determines that required performance time is not long, and the response output unit 100b ends the process. Note that the response output unit 100b ends the process after the performance notification accepting unit 107 accepts a performance completion notification outputted from target equipment and the output control unit 105 outputs information indicating a performance response.

If the time determining unit 103 determines at step ST2303 that the first predicted elapsed time exceeds n4 seconds (if “YES” at step ST2303), then the time determining unit 103 determines that the required performance time is long, and outputs function performance delay information to the response sentence determining unit 104.

When the function performance delay information is outputted from the time determining unit 103 at step ST2303, the response sentence determining unit 104 determines a first response sentence corresponding to the first predicted elapsed time which is predicted by the predicting unit 110 at step ST2301, on the basis of equipment and function information obtained by the equipment and function information obtaining unit 101 at step ST2302 (step ST2304).

The response sentence determining unit 104 outputs information indicating the determined first response sentence to the output control unit 105.

FIG. 24 is a diagram showing an outline of the flow of time up to the time when the voice output device 42 is caused to output, by voice, a first response sentence with a length corresponding to first predicted elapsed time in a case where the equipment control device 1b according to the fifth embodiment has performed the operations described in FIG. 23 and determined that required performance time is long.

As described above, when first predicted elapsed time exceeds fourth target time, the equipment control device 1b outputs information indicating a first response sentence with a length corresponding to the first predicted elapsed time. Namely, in the equipment control device 1b, when it is predicted that the fourth target time elapses during a period from when uttered speech is obtained to when the function command output unit 202 outputs a function command, the time determining unit 103 determines that required performance time is long, and the output control unit 105 outputs information indicating a first response sentence with a length corresponding to the first predicted elapsed time, which is determined by the response sentence determining unit 104, to the voice output device 42. At that time, the equipment control device 1b changes the length of a first response sentence to be determined, on the basis of the length of the predicted first predicted elapsed time. Thus, even when the required performance time is long in a case where an instruction for performance of a target function by target equipment is given by the user making an utterance, during that period of time, the user can recognize whether or not the intended function is going to be performed by the equipment. In addition, the equipment control device 1b can further reduce a possibility that the user feels that “he or she is kept waiting”, compared to a case in which the voice output device 42 is caused to output, by voice, a first response sentence with a fixed length regardless of the length of the required performance time.

Although in the above-described fifth embodiment, first predicted elapsed time which is predicted by the predicting unit 110 is elapsed time from a speech obtained time to output of a function command from the function command output unit 202, this is merely an example.

For example, the first predicted elapsed time may be time from a speech obtained time until a function command outputted from the function command output unit 202 reaches target equipment. In addition, for example, the first predicted elapsed time may be time from a speech obtained time until the performance notification accepting unit 107 accepts a performance completion notification which is transmitted from the target equipment in response to a function command outputted from the function command output unit 202.

The predicting unit 110 can calculate time predicted to be required for a function command to reach target equipment and time predicted to be required for a performance completion notification transmitted from the target equipment to reach the performance notification accepting unit 107, on the basis of information about an Internet environment, using an existing technique. In addition, the predicting unit 110 can calculate time predicted to be required for the target equipment to perform a target function, on the basis of information about records of processing time of the target function on the target equipment, the information being stored in advance. The predicting unit 110 may predict first predicted elapsed time on the basis of each of the above-described pieces of time that can be calculated.

In addition, for example, the predicting unit 110 may predict, as first predicted elapsed time, elapsed time from a time at which target equipment and a target function are determined (hereinafter referred to as a “target function determined time”.) until the function command output unit 202 outputs a function command, on the basis of equipment and function information outputted from the speech control device 300, in other words, information obtained after determining the target equipment and the target function.

In the fifth embodiment, for example, the target function determined time is a time at which the equipment and function determining unit 304 has obtained equipment and function information. The predicting unit 110 can obtain the target function determined time from the equipment and function determining unit 304. For example, the equipment and function determining unit 304 adds information indicating a target function determined time to equipment and function information, and outputs the resultant equipment and function information to the predicting unit 110.

In addition, in the fifth embodiment, the target function determined time may be a time at which the predicting unit 110 has obtained equipment and function information from the equipment and function determining unit 304.

By using, as first predicted elapsed time, elapsed time from a target function determined time until the function command output unit 202 outputs a function command, and predicting the first predicted elapsed time on the basis of equipment and function information, the predicting unit 110 can identify a target function and then predict the first predicted elapsed time. When the predicting unit 110 identifies a target function and then predicts first predicted elapsed time, compared to a case in which the predicting unit 110 uses, as first predicted elapsed time, elapsed time from a speech obtained time to output of a function command from the function command output unit 202, and predicts the first predicted elapsed time, the first predicted elapsed time can be more accurately predicted.

As such, the predicting unit 110 may use, as first predicted elapsed time, elapsed time from a speech obtained time to output of a function command from the function command output unit 202, or may use, as first predicted elapsed time, elapsed time from a target function determined time to output of a function command from the function command output unit 202.

As described above, according to the fifth embodiment, the equipment control device 1b is configured in such a manner that the equipment control device 1b includes the predicting unit 110 that predicts first predicted elapsed time from utterance to performance of a target function, and the time determining unit 103 determines whether or not time from the utterance to the performance of the target function is long, on the basis of the first predicted elapsed time which is predicted by the predicting unit 110, and when the time determining unit 103 has determined that the time from the utterance to the performance of the target function is long, the response sentence determining unit 104 determines, on the basis of equipment and function information obtained by the equipment and function information obtaining unit 101, a first response sentence with a length corresponding to the first predicted elapsed time which is predicted by the predicting unit 110. Hence, in a technique in which equipment is controlled on the basis of a result of speech recognition performed for user's uttered speech, even when time from utterance to performance of a function by the equipment is long, during that period of time, the user can recognize whether or not the intended function is going to be performed by the equipment In addition, the equipment control device 1b can further reduce a possibility that the user feels that “he or she is kept waiting”, compared to a case in which the voice output device 42 is caused to output, by voice, a first response sentence with a fixed length regardless of the length of required performance time.

### Sixth Embodiment

In the fifth embodiment, first predicted elapsed time is predicted, and when it is determined that required performance time is long, on the basis of the predicted first predicted elapsed time, a first response sentence with a length corresponding to the first predicted elapsed time is determined.

In a sixth embodiment, an embodiment will be described in which information which indicates a first response sentence and which causes the voice output device 42 to output, by voice, the first response sentence at a speed based on first predicted elapsed time is outputted.

The configuration of an equipment control system 1000 including an equipment control device 1b according to the sixth embodiment is the same as the configuration of the equipment control system 1000 described using FIG. 1 in the first embodiment, and thus, an overlapping description is omitted.

In addition, the configuration of the equipment control device 1b according to the sixth embodiment is the same as the configuration described using FIGS. 2 to 3 in the first embodiment and the configuration described using FIG. 21 in the fifth embodiment, and thus, an overlapping description is omitted.

Note that in the equipment control device 1b according to the sixth embodiment, the operations of a predicting unit 110, a response sentence determining unit 104, and an output control unit 105 differ from the operations of the predicting unit 110, the response sentence determining unit 104, and the output control unit 105 in the equipment control device 1b according to the fifth embodiment.

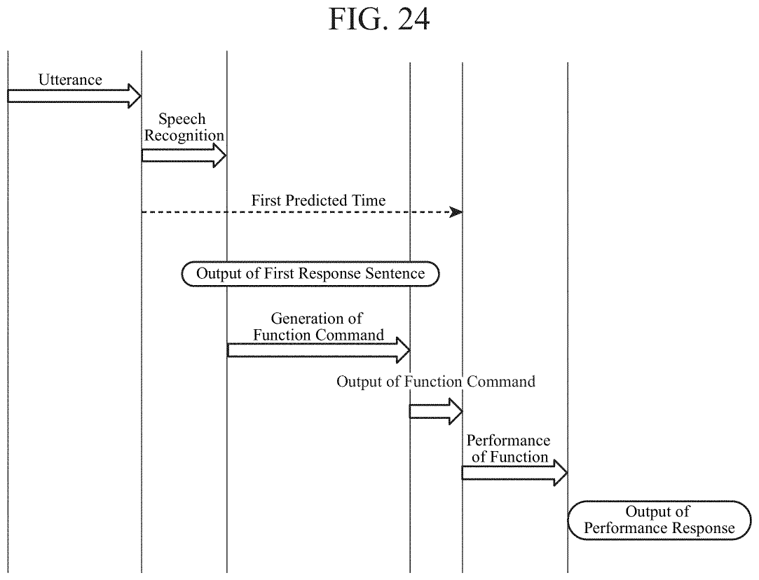

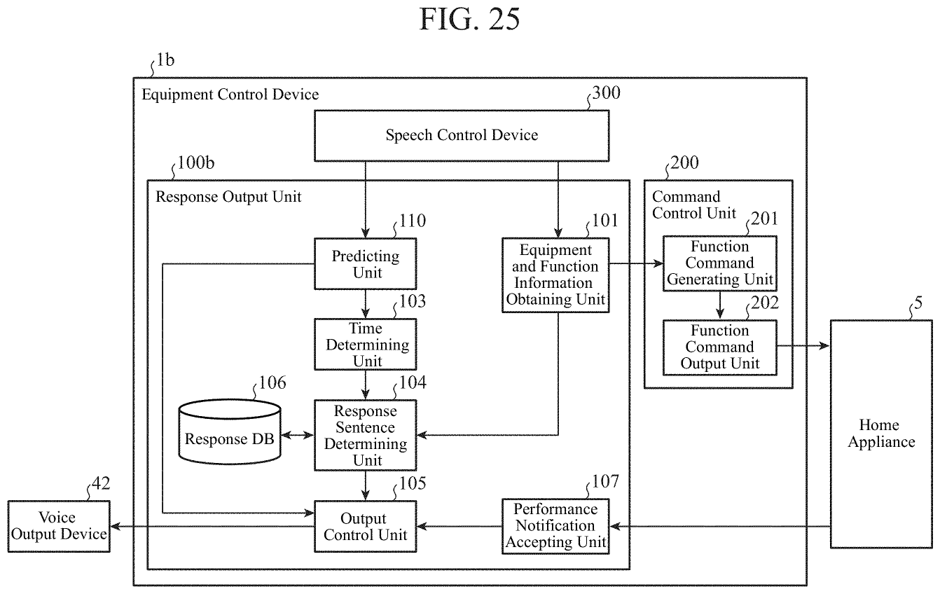

FIG. 25 is a diagram showing an exemplary configuration of the equipment control device 1b according to the sixth embodiment.

As shown in FIG. 25, the predicting unit 110 outputs information indicating predicted first predicted elapsed time to the time determining unit 103 and to the output control unit 105.

When the output control unit 105 outputs information indicating a first response sentence, the output control unit 105 provides, on the basis of the information indicating first predicted elapsed time outputted from the predicting unit 110, information indicating a speed at which the first response sentence is outputted by voice (hereinafter, referred to as “response sentence output speed information”.) and which is adjusted on the basis of the first predicted elapsed time, to the information indicating a first response sentence, and outputs the resultant information indicating a first response sentence.

The output control unit 105 sets, for example, the speed which causes output of the first response sentence to be completed within the first predicted elapsed time, as the speed at which the first response sentence is outputted by voice. Note that it is assumed that how much time it takes for the voice output device 42 to output, by voice, a first response sentence with a given length is determined in advance.

The voice output device 42 outputs, in accordance with the information which indicates a first response sentence and which is outputted from the output control unit 105, the first response sentence by voice at a playback speed based on the response sentence output speed information which is provided to the information indicating a first response sentence.

When the time determining unit 103 has determined that required performance time is long, the response sentence determining unit 104 determines a first response sentence on the basis of equipment and function information obtained by the equipment and function information obtaining unit 101 and on the basis of first response sentence information such as that shown using FIG. 5 in the first embodiment. A specific operation of determining a first response sentence is already described in the first embodiment, and thus, an overlapping description thereof is omitted.

The operations of the response output unit 100b in the equipment control device 1b according to the sixth embodiment will be described.

Note that the basic operations of the equipment control device 1b according to the sixth embodiment are the same as the basic operations of the equipment control device 1 which are described using the flowchart of FIG. 7 in the first embodiment, and thus, an overlapping description is omitted. Note also that the detailed operations of the command control unit 200 in the equipment control device 1b according to the sixth embodiment are the same as the detailed operations of the command control unit 200 which are described using FIG. 9 in the first embodiment, and thus, an overlapping description is omitted.

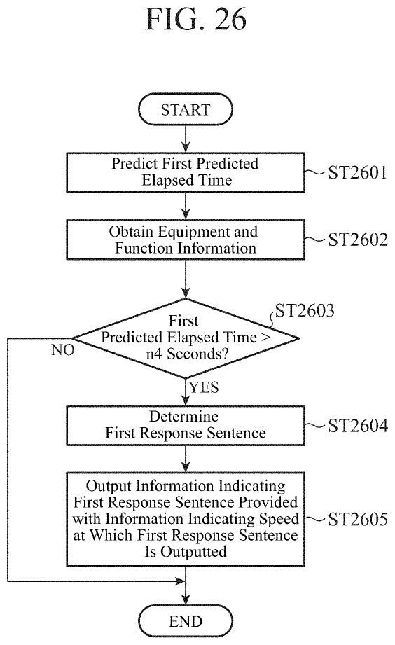

FIG. 26 is a flowchart for describing the detailed operations of the response output unit 100b in the equipment control device 1b according to the sixth embodiment.

Specific operations at steps ST2601 to ST2604 of FIG. 26 are the same as specific operations at steps ST2301 to ST2303 of FIG. 23 described in the fifth embodiment and at step ST805 of FIG. 8 described in the first embodiment, respectively, and thus, an overlapping description is omitted.

The output control unit 105 outputs information indicating a first response sentence which is determined by the response sentence determining unit 104 at step ST2604, to the voice output device 42. Upon the output, the output control unit 105 adjusts a speed at which the first response sentence is outputted by voice, on the basis of first predicted elapsed time which is predicted by the predicting unit 110 at step ST2601, provides response sentence output speed information to the information indicating the first response sentence, and outputs the resultant information indicating the first response sentence to the voice output device 42 (step ST2605).

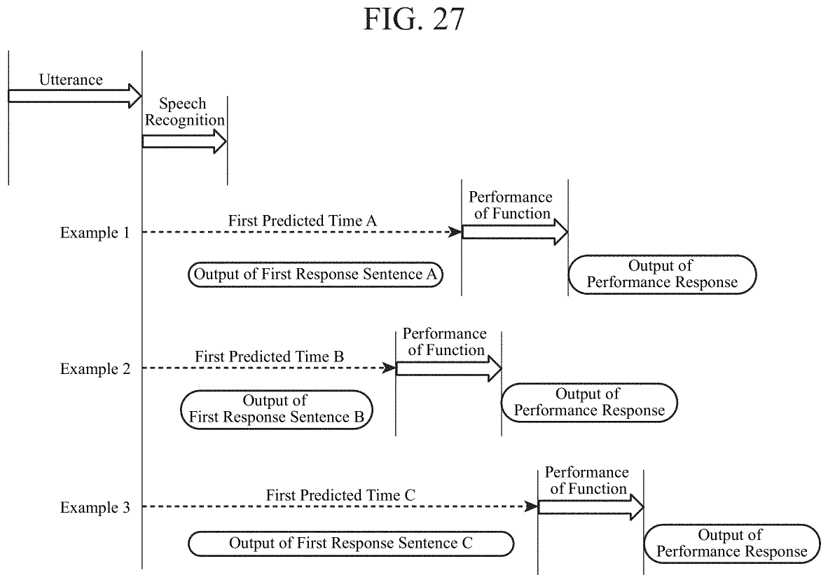

FIG. 27 is a diagram showing an outline of the flow of time up to the time when the voice output device 42 is caused to output, by voice, a first response sentence at a speed based on first predicted elapsed time in a case where the equipment control device 1b according to the sixth embodiment has performed the operations described in FIG. 26 and determined that required performance time is long.

As shown in example 1 of FIG. 27, for example, when the predicting unit 110 predicts first predicted elapsed time A, the output control unit 105 outputs information indicating a first response sentence A provided with response sentence output speed information based on the first predicted elapsed time A, to the voice output device 42. The voice output device 42 outputs the first response sentence A by voice at a speed based on the first predicted elapsed time A, in accordance with the information indicating the first response sentence A.

As described above, in the equipment control device 1b, the predicting unit 110 predicts first predicted elapsed time, and the time determining unit 103 determines that required performance time is long when the first predicted elapsed time exceeds fourth target time. Then, when the output control unit 105 outputs information indicating a first response sentence, the output control unit 105 provides response sentence output speed information to the information indicating a first response sentence on the basis of the first predicted elapsed time which is predicted by the predicting unit 110, and outputs the resultant information indicating a first response sentence.

The equipment control device 1b changes the playback speed of a first response sentence to be outputted by voice from the voice output device 42, on the basis of the length of predicted first predicted elapsed time. Thus, even when required performance time is long in a case where an instruction for performance of a target function by target equipment is given by the user making an utterance, during that period of time, the user can recognize whether or not the intended function is going to be performed by the equipment. In addition, the equipment control device 1b can further reduce a possibility that the user feels that “he or she is kept waiting”, compared to a case in which the voice output device 42 is caused to output, by voice, a first response sentence with a fixed length regardless of the length of the required performance time.

As described above, according to the sixth embodiment, the equipment control device 1b is configured in such a manner that the equipment control device 1b includes the predicting unit 110 that predicts first predicted elapsed time from utterance to performance of a target function, and the time determining unit 103 determines whether or not time from the utterance to the performance of the target function is long, on the basis of the first predicted elapsed time predicted by the predicting unit 110, and when the time determining unit 103 has determined that the time from the utterance to the performance of the target function is long, the output control unit 105 provides information indicating a speed at which a first response sentence is outputted by voice and which is adjusted on the basis of the first predicted elapsed time predicted by the predicting unit 110, to information indicating the first response sentence, and outputs the resultant information indicating the first response sentence. Hence, in a technique in which equipment is controlled on the basis of a result of speech recognition performed for user's uttered speech, even when time from utterance to performance of a function by the equipment is long, during that period of time, the user can recognize whether or not the intended function is going to be performed by the equipment. In addition, the equipment control device 1b can further reduce a possibility that the user feels that “he or she is kept waiting”, compared to a case in which the voice output device 42 is caused to output, by voice, a first response sentence with a fixed length regardless of the length of required performance time.

### Seventh Embodiment

In the first embodiment, when the equipment control device 1 determines that required performance time is long, regardless of the content of user's utterance, a first response sentence is outputted by voice from the voice output device 42.

In a seventh embodiment, an embodiment will be described in which when a target equipment's target function performance of which is ordered by the user making an utterance is an urgent function, a message prompting the user to perform a manual operation is outputted by voice from the voice output device 42.

The configuration of an equipment control system 1000 including an equipment control device 1c according to the seventh embodiment is the same as the configuration of the equipment control system 1000 described using FIG. 1 in the first embodiment, and thus, an overlapping description is omitted.

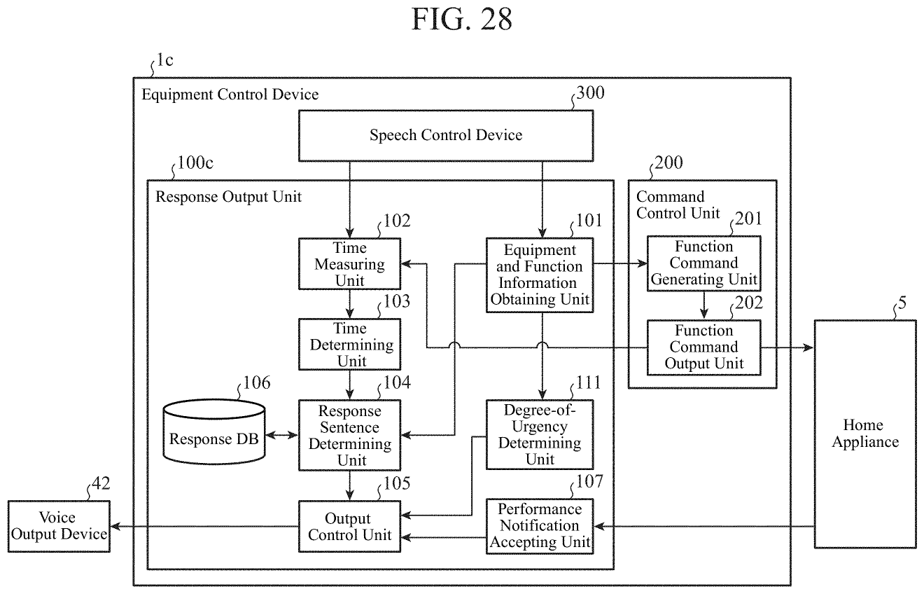

FIG. 28 is a diagram showing an exemplary configuration of the equipment control device 1c according to the seventh embodiment.

In FIG. 28, the same components as those of the equipment control device 1 according to the first embodiment are given the same reference signs, and an overlapping description thereof is omitted. In addition, an exemplary schematic configuration of the equipment control device 1c and an exemplary configuration of the speech control device 300 in the equipment control device 1c are the same as an exemplary schematic configuration of the equipment control device 1 and an exemplary configuration of the speech control device 300 in the equipment control device 1 which are described using FIGS. 2 and 3 in the first embodiment, and thus, an overlapping description is omitted.

The equipment control device 1c according to the seventh embodiment differs from the equipment control device 1 according to the first embodiment in that a response output unit 100c includes a degree-of-urgency determining unit 111.

The degree-of-urgency determining unit 111 determines a degree of urgency of a target function to be performed by target equipment, on the basis of equipment and function information obtained by the equipment and function information obtaining unit 101. Note that in the seventh embodiment, the equipment and function information obtaining unit 101 outputs equipment and function information obtained from the equipment and function determining unit 304, to the response sentence determining unit 104, the function command generating unit 201, and the degree-of-urgency determining unit 111.

A specific example is as follows. When in equipment and function information, “Stop immediately”, “Turn the gas range off immediately”, or the like, is associated as a target function, the degree-of-urgency determining unit 111 determines that the target function is an urgent function and has a high degree of urgency.

For example, the storage unit stores in advance urgent function information that defines an urgent function such as “Stop immediately” or “Turn the gas range off immediately”, and the degree-of-urgency determining unit 111 determines a degree of urgency of a target function to be performed by target equipment, on the basis of the urgent function information. When a target function included in equipment and function information is defined in the urgent function information, the degree-of-urgency determining unit 111 determines that the degree of urgency of the target function to be performed by target equipment is high.

In addition, when a result of speech recognition is included in equipment and function information, the degree-of-urgency determining unit 111 may determine a degree of urgency of a target function to be performed by target equipment, on the basis of the result of speech recognition. A specific example is as follows. For example, when a result of speech recognition includes a word that expresses emotion, the degree-of-urgency determining unit 111 may determine that the degree of urgency of a target function to be performed by target equipment is high. The degree-of-urgency determining unit 111 estimates whether or not a result of speech recognition includes a word that expresses emotion, using an existing emotion estimation technique.

Note that although in the seventh embodiment, as described above, the degree-of-urgency determining unit 111 obtains a result of speech recognition from the equipment and function determining unit 304, the degree-of-urgency determining unit 111 may obtain a result of speech recognition from the speech recognizing unit 302.

When the degree-of-urgency determining unit 111 has determined that the degree of urgency of a target function to be performed by target equipment is high, the degree-of-urgency determining unit 111 outputs information indicating that the degree of urgency is high (hereinafter, referred to as “urgent function ordering information”.) to the output control unit 105.

When urgent function ordering information is outputted from the degree-of-urgency determining unit 111, the output control unit 105 outputs information indicating a message prompting a manual operation on the target equipment. The message prompting a manual operation on the target equipment is, for example, “Please operate manually”.

In accordance with information indicating “Please operate manually” which is outputted from the output control unit 105, the voice output device 42 outputs “Please operate manually” by voice.

The operations of the response output unit 100c in the equipment control device 1c according to the seventh embodiment will be described in detail.

Note that the basic operations of the equipment control device 1c according to the seventh embodiment are the same as the basic operations of the equipment control device 1 which are described using the flowchart of FIG. 7 in the first embodiment, and thus, an overlapping description is omitted. Note also that the detailed operations of the command control unit 200 in the equipment control device 1c according to the seventh embodiment are the same as the detailed operations of the command control unit 200 which are described using FIG. 9 in the first embodiment, and thus, an overlapping description is omitted.

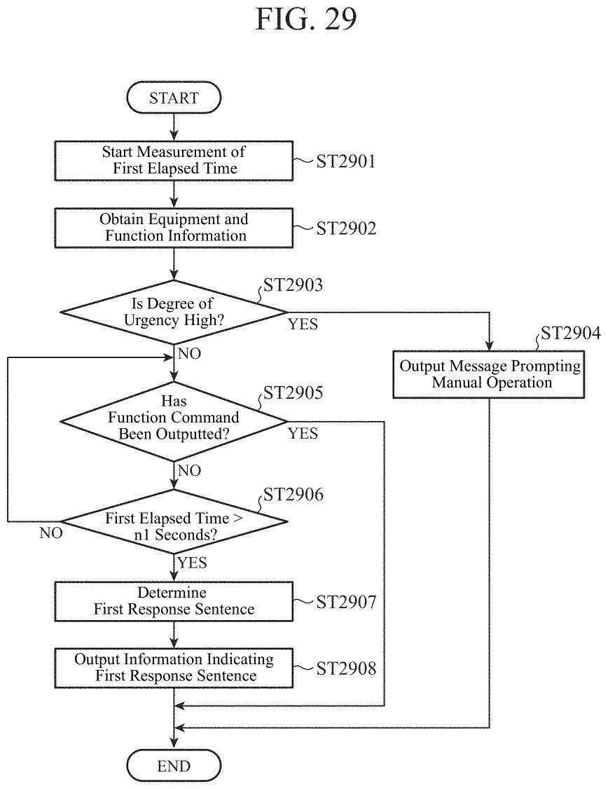

FIG. 29 is a flowchart for describing the detailed operations of the response output unit 100c in the equipment control device 1c according to the seventh embodiment.

Specific operations at steps ST2901 to ST2902 and ST2905 to ST2908 of FIG. 29 are the same as specific operations at steps ST801 to ST806 of FIG. 8 which are described in the first embodiment, respectively, and thus, an overlapping description is omitted.

When equipment and function information is outputted from the equipment and function information obtaining unit 101 at step ST2902, the degree-of-urgency determining unit 111 determines a degree of urgency of a target function to be performed by target equipment, on the basis of the equipment and function information obtained by the equipment and function information obtaining unit 101 (step ST2903).

If the degree-of-urgency determining unit 111 determines at step ST2903 that the degree of urgency of the target function to be performed by the target equipment is low (if “NO” at step ST2903), then the equipment control device 1c proceeds to a process at step ST2905.

If the degree-of-urgency determining unit 111 determines at step ST2903 that the degree of urgency of the target function to be performed by the target equipment is high (if “YES” at step ST2903), then the degree-of-urgency determining unit 111 outputs urgent function ordering information to the output control unit 105.

If urgent function ordering information is outputted from the degree-of-urgency determining unit 111 at step ST2903, then the output control unit 105 outputs information indicating a message prompting a manual operation on the target equipment (step ST2904).

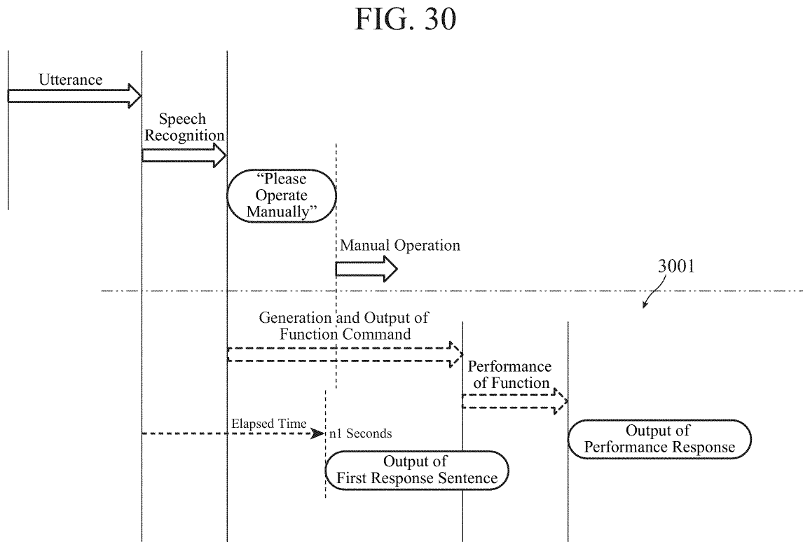

FIG. 30 is a diagram showing an outline of the flow of time in a case in which a message prompting a manual operation on target equipment is outputted by voice from the voice output device 42 when the equipment control device 1c according to the seventh embodiment has performed the operations described in FIG. 29 and determined that the degree of urgency of a target function to be performed by the target equipment is high.

Note that FIG. 30 also shows, for comparison, an outline of the flow of time up to the time when a first response sentence is outputted by voice from the voice output device 42 in a case where the equipment control device 1c has determined that the degree of urgency of the target function to be performed by the target equipment is low and determined that required performance time is long (see 3001 of FIG. 30).

As described above, when a target equipment's target function performance of which is ordered by the user making an utterance is an urgent function, the equipment control device 1c causes the voice output device 42 to output, by voice, a message prompting the user to perform a manual operation.

Namely, in the equipment control device 1c, when the degree-of-urgency determining unit 111 has determined that a degree of urgency of a target function to be performed by target equipment is high, the output control unit 105 outputs information indicating a message prompting a manual operation on the target equipment to the voice output device 42.

When a target equipment's target function performance of which is ordered by the user making an utterance is an urgent function, the equipment control device 1c can prompt the user to perform the target function immediately without causing the user to wait until the target function is performed by the target equipment.

Note that although in the above description, the seventh embodiment is applied to the equipment control device 1 according to the first embodiment, and thereby the equipment control device 1 according to the first embodiment includes the degree-of-urgency determining unit 111, this is merely an example. It is also allowed that the seventh embodiment is applied to the equipment control devices 1 and 1b according to the second to sixth embodiments, and thereby the equipment control devices 1 and 1b according to the second to sixth embodiments include the degree-of-urgency determining unit 111.

As described above, according to the seventh embodiment, the equipment control device 1c is configured in such a manner that the equipment control device 1c includes the degree-of-urgency determining unit 111 that determines a degree of urgency of a target function to be performed by target equipment, and when the degree-of-urgency determining unit 111 determines that the degree of urgency of the target function to be performed by the target equipment is high, the output control unit 105 outputs information indicating a message prompting a manual operation on the target equipment. Hence, when a target equipment's target function performance of which is ordered by the user making an utterance is an urgent function, the equipment control device 1c can prompt the user to perform the target function immediately without causing the user to wait until the target function is performed by the target equipment.

### Eighth Embodiment

In the first embodiment, the equipment control device 1 outputs information indicating a first response sentence for outputting the first response sentence by voice.

In an eighth embodiment, an embodiment will be described in which information indicating a first response sentence for displaying the first response sentence is outputted.

The configuration of an equipment control system 1000 including an equipment control device 1 according to the eighth embodiment is the same as the configuration of the equipment control system 1000 described using FIG. 1 in the first embodiment, and thus, an overlapping description is omitted.

In addition, the configuration of the equipment control device 1 according to the eighth embodiment is the same as the configuration described using FIGS. 2 to 4 in the first embodiment, and thus, an overlapping description is omitted.

Note that in the equipment control device 1 according to the eighth embodiment, the operations of an output control unit 105 differ from the operations of the output control unit 105 in the equipment control device 1 according to the first embodiment.

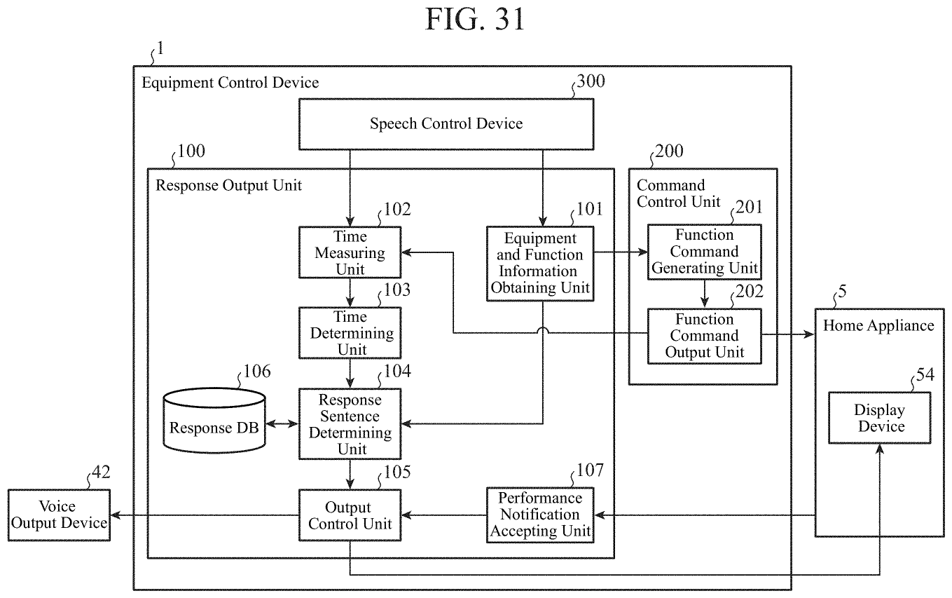

FIG. 31 is a diagram showing an exemplary configuration of the equipment control device 1 according to the eighth embodiment.

As shown in FIG. 31, the output control unit 105 outputs information indicating a first response sentence to the voice output device 42 and to a display device 54. Note that the information indicating a first response sentence which is outputted to the voice output device 42 from the output control unit 105 is information for outputting the first response sentence by voice, and the information indicating a first response sentence which is outputted to the display device 54 from the output control unit 105 is information for displaying the first response sentence.

In the eighth embodiment, it is assumed that as shown in FIG. 31, the display device 54 is included in the home appliance 5 which is target equipment.

The output control unit 105 outputs information indicating a first response sentence for displaying the first response sentence to the display device 54. The first response sentence to be displayed on the display device 54 by the output control unit 105 may be a character string or may be an illustration or an icon.

The basic operations of the equipment control device 1 according to the eighth embodiment are the same as the basic operations of the equipment control device 1 which are described using the flowchart of FIG. 7 in the first embodiment, and thus, an overlapping description is omitted. Note also that the detailed operations of the command control unit 200 in the equipment control device 1 according to the eighth embodiment are the same as the detailed operations of the command control unit 200 which are described using FIG. 9 in the first embodiment, and thus, an overlapping description is omitted.

A flowchart showing the detailed operations of the response output unit 100 in the equipment control device 1 according to the eighth embodiment is the same as the flowchart of FIG. 8 shown in the first embodiment, and thus, the detailed operations of the response output unit 100 in the equipment control device 1 according to the eighth embodiment will be described using the flowchart of FIG. 8.

Note that specific operations at steps ST801 to ST805 for the equipment control device 1 according to the eighth embodiment are the same as specific operations at steps ST801 to ST805 for the equipment control device 1 according to the first embodiment which are already described, and thus, an overlapping description is omitted.

At step ST806, the output control unit 105 outputs information indicating a first response sentence to the voice output device 42, and outputs information indicating a first response sentence to the display device 54.

As described above, the equipment control device 1 outputs information indicating a first response sentence for displaying the first response sentence, in addition to information indicating a first response sentence for outputting the first response sentence by voice.

As a result, hence, in a technique in which equipment is controlled on the basis of a result of speech recognition performed for user's uttered speech, even when time from utterance to performance of a function by the equipment is long, during that period of time, the user can also visually recognize whether or not the intended function is going to be performed by the equipment.

Note that although in the above description, the output control unit 105 outputs information indicating a first response sentence to the voice output device 42 and the display device 54, this is merely an example. The output control unit 105 may output information indicating a first response sentence only to the display device 54.

In addition, although in the above description, the eighth embodiment is applied to the equipment control device 1 according to the first embodiment, this is merely an example. It is also allowed that the eighth embodiment is applied to the equipment control devices 1 to 1c according to the second to seventh embodiments, and thereby the equipment control devices 1 to 1c according to the second to seventh embodiments output information indicating a first response sentence, information indicating a second response sentence, or information indicating a message prompting a manual operation on target equipment for displaying the first response sentence, the second response sentence, or the message prompting a manual operation on target equipment. When the eighth embodiment is applied to the seventh embodiment, the equipment control device 1c outputs information indicating a message prompting a manual operation on target equipment, and thereby for example, the message can also be displayed blinking red on the display device 54.

As described above, according to the eighth embodiment, the equipment control device 1 is configured in such a manner that the output control unit 105 outputs information for displaying a first response sentence. Hence, in a technique in which equipment is controlled on the basis of a result of speech recognition performed for user's uttered speech, even when time from utterance to performance of a function by the equipment is long, during that period of time, the user can also visually recognize whether or not the intended function is going to be performed by the equipment.

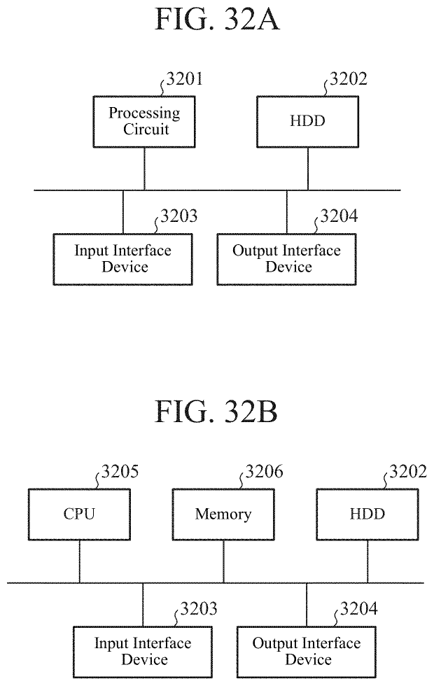

FIGS. 32A and 32B are diagrams showing examples of a hardware configuration of the equipment control devices 1 to 1c according to the first to eighth embodiments.

In the first to eighth embodiments, the functions of the speech obtaining unit 301, the speech recognizing unit 302, the equipment and function determining unit 304, the response output unit 100, and the command control unit 200 are implemented by a processing circuit 3201. Namely, the equipment control devices 1 to 1c each include the processing circuit 3201 for performing control to output information indicating a first response sentence related to a target function when it is determined that time from user's utterance to performance of the target function is long.

The processing circuit 3201 may be dedicated hardware as shown in FIG. 32A or may be a central processing unit (CPU) 3205 as shown in FIG. 32B that executes a program stored in a memory 3206.

When the processing circuit 3201 is dedicated hardware, the processing circuit 3201 corresponds, for example, to a single circuit, a combined circuit, a programmed processor, a parallel programmed processor, an application specific integrated circuit (ASIC), a field-programmable gate array (FPGA), or a combination thereof.

When the processing circuit 3201 is the CPU 3205, the functions of the speech obtaining unit 301, the speech recognizing unit 302, the equipment and function determining unit 304, the response output unit 100, and the command control unit 200 are implemented by software, firmware, or a combination of software and firmware. Namely, the speech obtaining unit 301, the speech recognizing unit 302, the equipment and function determining unit 304, the response output unit 100, and the command control unit 200 are implemented by a processing circuit such as the CPU 3205 that executes a program stored in a hard disk drive (HDD) 3202, the memory 3206, etc., or a system large-scale integration (LSI). In addition, it can also be said that the program stored in the HDD 3202, the memory 3206, or the like, causes a computer to perform the procedures or methods performed by the speech obtaining unit 301, the speech recognizing unit 302, the equipment and function determining unit 304, the response output unit 100, and the command control unit 200. Here, the memory 3206 corresponds, for example, to a nonvolatile or volatile semiconductor memory such as a random access memory (RAM), a read only memory (ROM), a flash memory, an erasable programmable read only memory (EPROM), or an electrically erasable programmable read-only memory (EEPROM), a magnetic disk, a flexible disk, an optical disc, a compact disc, a MiniDisc, or a digital versatile disc (DVD).

Note that some of the functions of the speech obtaining unit 301, the speech recognizing unit 302, the equipment and function determining unit 304, the response output unit 100, and the command control unit 200 may be implemented by dedicated hardware, and some of the functions may be implemented by software or firmware. For example, it is possible to implement the function of the response output unit 100 by the processing circuit 3201 which is dedicated hardware, and implement the functions of the speech obtaining unit 301, the speech recognizing unit 302, the equipment and function determining unit 304, and the command control unit 200 by a processing circuit reading and executing a program stored in the memory 3206.

In addition, as the speech recognition dictionary DB 303, the equipment and function DB 305, the response DB 106, and the storage unit which is not shown, the memory 3206 is used. Note that this is an example and the speech recognition dictionary DB 303, the equipment and function DB 305, the response DB 106, and the storage unit which is not shown may be composed of the HDD 3202, a solid state drive (SSD), a DVD, or the like.

In addition, the equipment control devices 1 to 1c each include an input interface device 3203 and an output interface device 3204 that perform communication with the voice input device 41, the voice output device 42, the home appliance 5, or the like.

Note that although in the above-described first to eighth embodiments, the speech control device 300 is included in the equipment control devices 1 to 1c, this is merely an example. The speech control device 300 may be provided external to the equipment control devices 1 to 1c and connected to the equipment control devices 1 to 1c through a network.

In addition, although in the above-described first to eighth embodiments, target equipment is the home appliance 5, the target equipment is not limited to the home appliance 5. For example, various types of equipment that can perform their functions on the basis of results of speech recognition based on uttered speech, such as equipment installed in factories, smartphones, and in-vehicle equipment, can be used as target equipment.

In addition, although in the above-described first to eighth embodiments, as shown in FIG. 1, in the equipment control system 1000, the equipment control devices 1 to 1c, the voice input device 41, the voice output device 42, and the home appliance 5 are described as independent devices, this is merely an example.

For example, the voice input device 41 and the voice output device 42 may be mounted on the home appliance 5.

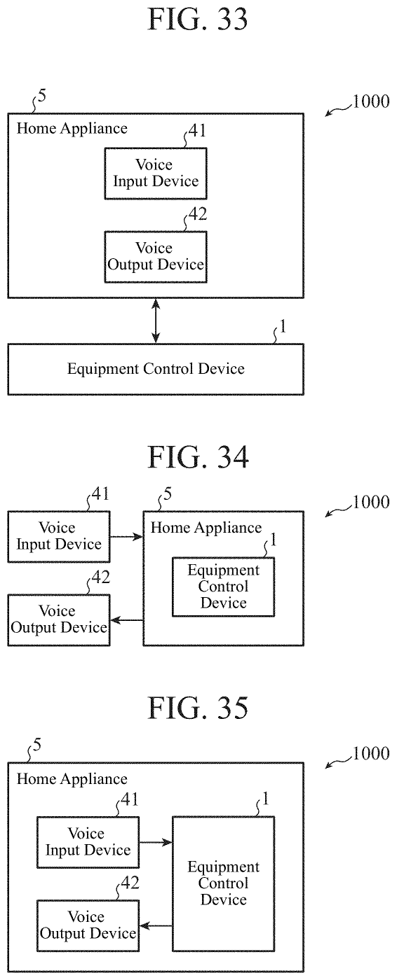

FIG. 33 shows an exemplary configuration of the equipment control system 1000 according to the first embodiment when in the equipment control system 1000, the voice input device 41 and the voice output device 42 are mounted on the home appliance 5. Note that in FIG. 33, description of the detail configurations of the equipment control device 1 and the home appliance 5 is omitted.

In addition, for example, the equipment control devices 1 to 1c may be mounted on the home appliance 5.

FIG. 34 shows an exemplary configuration of the equipment control system 1000 according to the first embodiment when in the equipment control system 1000, the equipment control device 1 is mounted on the home appliance 5. Note that in FIG. 34, description of the detail configurations of the equipment control device 1 and the home appliance 5 is omitted.

In addition, for example, the equipment control devices 1 to 1c, the voice input device 41, and the voice output device 42 may be mounted on the home appliance 5.

FIG. 35 shows an exemplary configuration of the equipment control system 1000 according to the first embodiment when in the equipment control system 1000, the equipment control device 1, the voice input device 41, and the voice output device 42 are mounted on the home appliance 5. Note that in FIG. 35, description of the detail configurations of the equipment control device 1 and the home appliance 5 is omitted.

In addition, although in the above description, it is assumed that the equipment control devices 1 to 1c are provided in a server external to a home and communicate with the home appliance 5 in home, no limitation thereto is intended. The equipment control devices 1 to 1c may be connected to a network in home.

In addition, in the invention of the present application, a free combination of the embodiments, modifications to any component of each of the embodiments, or omission of any component in each of the embodiments is possible within the scope of the invention.

### INDUSTRIAL APPLICABILITY

Equipment control devices according to the invention are configured in such a manner that in a technique in which equipment is controlled on the basis of a result of speech recognition performed for user's uttered speech, even when time from utterance to performance of a function by the equipment is long, during that period of time, the user can recognize whether or not the intended function is going to be performed by the equipment. Thus, the equipment control devices can be applied as, for example, equipment control devices that control equipment on the basis of a result of speech recognition performed for uttered speech.

### REFERENCE SIGNS LIST

1 to 1c: equipment control device, 4: smart speaker, 41: voice input device, 42: voice output device, 5: home appliance, 51: function command obtaining unit, 52: function command performing unit, 53: performance notifying unit, 54: display device, 100, 100a to 100c: response output unit, 101: equipment and function information obtaining unit, 102: time measuring unit, 103: time determining unit, 104: response sentence determining unit, 105: output control unit, 106: response DB, 107: performance notification accepting unit, 108: elapsed time from first response sentence output measuring unit, 109: elapsed time from first response sentence output determining unit, 110: predicting unit, 111: degree-of-urgency determining unit, 200: command control unit, 201: function command generating unit, 202: function command output unit, 300: speech control device, 301: speech obtaining unit, 302: speech recognizing unit, 303: speech recognition dictionary DB, 304: equipment and function determining unit, 305: equipment and function DB, 1000: equipment control system, 3201: processing circuit, 3202: HDD, 3203: input interface device, 3204: output interface device, 3205: CPU, 3206: memory

1. An equipment control device that controls equipment on a basis of a result of speech recognition performed for uttered speech, the equipment control device comprising:
processing circuitry
to obtain equipment and function information in which target equipment is associated with a target function to be performed by the target equipment, the target equipment and the target function being determined on a basis of the result of speech recognition;
to determine whether or not time from utterance to performance of the target function is long;
to determine a first response sentence related to the target equipment, on a basis of the obtained equipment and function information, when it has been determined that the time from utterance to performance of the target function is long;
to output information indicating the determined first response sentence;
to measure first elapsed time from obtainment of the uttered speech;
to generate a function command for performing the target function, on a basis of the obtained equipment and function information; and
to output the generated function command to the target equipment, wherein
when the measured first elapsed time has exceeded first target time, the processing circuitry determines that the time from utterance to performance of the target function is long, and
when the processing circuitry has outputted the function command, the processing circuitry ends the measurement of the first elapsed time.

2. The equipment control device according to claim 1, wherein
when the processing circuitry has completed the generation of the function command after the processing circuitry outputs the information indicating the first response sentence,
if output of the first response sentence based on the outputted information indicating the first response sentence has not been completed, then the processing circuitry suspends the output of the function command until the output of the first response sentence is completed.

3. The equipment control device according to claim 1, wherein
the processing circuitry measures elapsed time from first response sentence output that has elapsed from when the information indicating the first response sentence is outputted,
the processing circuitry determines whether or not the measured elapsed time from first response sentence output has exceeded third target time,
when it has been determined that the elapsed time from first response sentence output has exceeded the third target time, the processing circuitry determines a second response sentence, and
the processing circuitry outputs information indicating the determined second response sentence, in addition to the information indicating the first response sentence.

4. The equipment control device according to claim 3, wherein
the second response sentence is
a response sentence which is related to the target equipment, and which is based on the obtained equipment and function information or
an apology message.

5. The equipment control device according to claim 1, wherein
the processing circuitry determines a degree of urgency of the target function to be performed by the target equipment, and
when it has been determined that the degree of urgency of the target function to be performed by the target equipment is high, the processing circuitry outputs information indicating a message prompting a manual operation on the target equipment.

6. The equipment control device according to claim 1, wherein the information indicating the first response sentence is information for outputting the first response sentence by voice.

7. The equipment control device according to claim 1, wherein the information indicating the first response sentence is information for displaying the first response sentence.

8. An equipment control method for controlling equipment on a basis of a result of speech recognition performed for uttered speech, the equipment control method comprising:
obtaining equipment and function information in which target equipment is associated with a target function to be performed by the target equipment, the target equipment and the target function being determined on a basis of the result of speech recognition;
determining whether or not time from utterance to performance of the target function is long;
determining a first response sentence related to the target equipment, on a basis of the obtained equipment and function information, when it has been determined that the time from utterance to performance of the target function is long;
outputting information indicating the determined first response sentence;
measuring first elapsed time from obtainment of the uttered speech;
generating a function command for performing the target function, on a basis of the obtained equipment and function information;
outputting the generated function command to the target equipment;
when the measured first elapsed time has exceeded first target time, determining that the time from utterance to performance of the target function is long; and
when the function command has been outputted, ending the measurement of the first elapsed time.
